(19) United States
(12) Patent Application Publication
(10) Pub. No.: US 2008/0243674 A1
(43) Pub. Date: Oct. 2, 2008

(54) System for automated trading of informational items and having integrated ask-and -post features

(75) Inventors: Per Pettersen, Los Angeles, CA (US); Roger Kjensrud, Santa Barbara, CA (US); Knut Forkalsrud, Santa Barbara, CA (US); Corey Gerritsen, Los Angeles, CA (US)

Correspondence Address: MACPHERSON KWOK CHEN & HEID LLP, 2033 GATEWAY PLACE, SUITE 400, SAN JOSE, CA, 95110, US

(73) Assignee: LeadPoint, Inc.

(21) Appl. No.: 11/731,101

(22) Filed: Mar. 30, 2007

(51) Int. Cl. G06Q 30/00

(52) U.S. Cl. 705/37

(57) ABSTRACT

A hybrid system that supports automated trading of informational items between sellers of such items and buyers who bid on the items includes means for allowing bidders to subscribe to ask-and-post services. A buyer/bidder who subscribes to such services is given the opportunity to be presented with more detailed information about an informational item he or she has bid upon before being obligated to pay for the informational item. If a first asked bidder rejects the item after having been given the opportunity for a sneak peek (or if that first bidder times-out due to no response), then the opportunity is automatically presented to a next subscribing buyer/bidder listed on a dynamically generated list (e.g., a stochastic ordered list). In one class of embodiments, the informational items include lead information for making hot contact with a prospective consumer of predefined products and/or services.

### FIELD OF DISCLOSURE

The present disclosure of invention relates generally to automated pricing and trading systems and more specifically to structures and methods for auctioning off or bidding on detailed informational items such as leads that point to prospective customers where the leads are sourced from a leads-generating system to competing buyers of such leads. The disclosure relates more specifically to situations where the buyers (bidders) may want to subscribe to a closer-peek service that allows the bidders to take a look at more detailed information regarding the informational item they have bid for prior to indicating final acceptability of the bid-upon item and prior to entering a process under which they may become finally obligated to pay for the acceptable informational item.

### CROSS REFERENCE TO CO-OWNED, EARLY-PUBLISHED APPLICATIONS

The following copending U.S. patent applications are owned by the owner of the present application, have been published prior to grant by the U.S. Patent Office and their disclosures are incorporated herein by reference:

(A) Ser. No. 11/207,571 [Attorney Docket No. M-15954-US] filed Aug. 19, 2005 by Marc Diana and Per Pettersen and early published as US 20060041500 A1 on Feb. 23, 2006;

(B) Ser. No. 11/373,633 [Attorney Docket No. M-15954-1P-US] filed Mar. 9, 2006 by Per Pettersen and early published as US 20060155642 A1 on Jul. 13, 2006; and

(C) Ser. No. 11/412,238 [Attorney Docket No. M-15957-1P-US] filed Apr. 25, 2006 by Marc Diana and Per Pettersen and early published as US 20060265259 A1 on Nov. 23, 2006.

### DESCRIPTION OF RELATED ART

An astronomically large number of potential customers, clients or other potential consumers may be available for buying or otherwise acquiring vendible goods and/or services from corresponding vendors. The pool of potential consumers may include all natural persons as well as public and private corporations, partnerships, governmental organizations and other such entities. The pool of potential vendors may span an equally wide set of different kinds of entities.

Vendible goods and/or services can span a similarly large domain and may include anything from impulse purchase of items such as small candy bars to more methodically and rationally thought out acquisitions of financial instruments (e.g., home mortgages, loan refinancing packages) and/or of high-priced transportation vehicles (e.g., cars, trucks, airplanes etc.) and/or of high-priced other properties or services or combined packages of the same. The present disclosure is directed more so to the vending of moderate to high-end goods and/or services and to the process by which vendors of such goods and/or services or agents acting on their behalf or for their benefit are given the ability to sift through the potential consuming populace and to isolate and acquire desirable pointers, or “leads” that will allow the vendors/agents to connect with their respectively desired subsets of potential consumers.

A leads-providing industry has grown around the developing of short lists that identify optimally-ready and prospective consumers for various moderate and/or high-end goods and/or services. The industry may be vertically divided into a plurality of interlinked layers including: (a) a leads generation layer, (b) a leads selling layer, (c) a leads buying layer, and (d) a leads exploitation or converting layer where, for the last layer, purchased leads are followed through on in hopes of converting the leads into consummated vendor-consumer transactions (i.e., purchases of vendor offered good and/or services).

Unless otherwise indicated, the term “lead” will be understood herein to refer to any mechanism by which a potential consumer having good current or future prospects for purchasing or otherwise consuming one or more goods and/or services is connected directly or indirectly (and immediately or in the future) to a vendor of such goods and/or services (or vise versa) such that the vendor (or an agent acting on the vendor's behalf) can appeal directly or indirectly to the prospective consumer to purchase or otherwise consume one or more goods and/or services offered by the vendor. Leads may take many forms including but not limited to: (a) a live or on-hold telephone connection to a potentially interested consumer (a so-called “hot-contact”); (b) an ongoing Internet chat or other directed communication with a potentially interested consumer; and (c) one or more data sets that identify one or more potentially interested consumers and characteristics associated with their potential consumerism.

A variety of methods have been, and continue to be developed for originating leads and for conveying those leads up the vertically integrated, leads-processing market, from the originators of leads to the ultimate purchasers and users of those leads, namely, the vendors (or vendor representatives) who wish to convert a relatively large percentage of bought leads into actual consumer-vendor transactions that profitably close for the vendors and for allowing the vendors to sift through piles of prospective leads looking for the best ones to buy (i.e., best in terms of how the vendors themselves define what is best at the moment for themselves).

One new development in the industry is known as ping-and-post. It is generally performed on a proprietary basis between select lead-offerors and hand selected lead buyers in so far as what is currently known to the inventors and thus information regarding ping-and-post is limited if nonexistent in the public space. According to what little is known, the already-in-practice process takes place in the product area of generating leads pointing to workers who want a “payday loan”. A “payday loan” is a short term loan given to a worker who will soon get a paycheck (i.e., in a month or less) where the paycheck serves as the collateral for the loan. It allows a worker who is in immediate need of cash to get that cash in advance of getting his paycheck. Some lead-offerors have generated hand-crafted lists of preferred buyers who are known to participate in this unique market space. The names on the hand-crafted lists are fixed based on human-to-human pre-negotiations. In other words, each seller calls up his favorite buyers and asks, “Do you want to be on my ping-and-post list?” The lists are also fixed in terms of their ordering of the buyers. In other words, the determination of which buyer will be pinged first and which next is predetermined by the individual lead offeror and this order is fixed. The fixed lists are input into a computerized offering system. Whenever a new lead is developed for a “payday loan”, the offering system steps sequentially down the fixed list of the given lead offeror, offering the lead for a fixed and human-to-human pre-negotiated price first to the buyer at the top of the fixed list (asking him if he wants it) and if rejected, offering it to the next, fixedly-named potential buyer on the list and so on. When one of the pinged buyers accepts, the lead is “posted” to the account of the accepting buyer and he is obligated to pay the pre-negotiated fixed price for that accepted lead. Thus, because a fixed list of potential and pre-identified buyers is pinged and one of the pinged buyers can accept in response to a ping, the system is known as ping-and-post.

This fixed-list and fixed-price ping-and-post system has numerous drawbacks. The buyers named on the list are fixed and their order is fixed. The human-to-human pre-negotiated price for the lead is fixed at least with respect to each buyer. Each lead seller operates his own decentralized, ping-and-post system and thus buyers must deal individually with the ping-and-post offerings of segregated sellers rather than dealing with an integrated marketplace. It is believed that heretofore no automated system has been available for providing an integrated and flexible ask-and-post process where the offerings of different sellers are combined and presented in a competitive market arrangement to a variable pool of lead buyers.

Automated auctioning systems have been developed independently of the recently emergent ping-and-post process. Specific techniques and structures for generating leads and/or automatically matching leads with lead-buyers have been disclosed in one or more of the above cited, copending and early-published patent applications: U.S. Ser. Nos. 11/207,571; 11/373,633 and 11/412,238 and as such many details regarding those techniques and structures will not be verbatim repeated here. Briefly, techniques are described for attracting potential consumers to web sites or other attractor means that relate to products and/or services which the consumers may be interested in acquiring. Techniques are disclosed for converting visits into detailed lead data. Techniques are disclosed for cross-matching lead data with bidding profiles provided by potential lead buyers and for enabling automated selling or auctioning of leads to highest bidders (or sometimes to bidders who are less than the highest so the latter are not locked out from participating by bidders with greater financial strength).

The lead selling business generally calls for a disquieting dance of hide and seek between sellers and buyers. Sellers generally do not want to disclose all the details of each lead item to potential buyers prior to sale because then the buyers (especially if unscrupulous) may feel that they have no need to pay for the lead, given that the potential buyers have already acquired all the information immediately contained in the lead without yet paying for it (or contracting to pay for it). Buyers do not want to disclose information such as that regarding their specific interest in the leads to sellers because then the sellers may detect how eager the buyer(s) is/are for the given lead(s) and may raise the price above what it would otherwise fetch in a more long-armed and sealed bid type of marketplace. The dance leads to a situation where potential buyers are usually kept in the dark about many details of the lead until after they have paid for it or have legally obligated themselves to pay for it. In other words, buyers are often forced to buy leads on an “as is” basis without right to closer inspection. Take it or leave it but you are not allowed to get close to the merchandise to better appreciate what you are bidding on.

An analogy may be made to a fisherman who casts his net into the dark waters of the sea, feels by touch that a load of fish has been snared by the underwater net and is then called upon to pay a price certain for the snared load even before the fisherman has a chance to pull the net up, to inspect the catch more closely and to determine whether all of the caught fish are the right kind or whether some must be/should be tossed back into the sea (for whatever reason) and are thus of no or little value to the fisherman. Understandably, the fisherman may feel cheated if he elects to pay a relatively high price for those of the caught fish which are of lesser or no value to that fisherman. It is a guessing game that can leave some players feeling cheated if lady luck is more often not on their side rather than with them.

Numerous advances have been made in the leads generating and/or leads matching and/or leads selling domains for increasing the probability that buyers will be happy with the catch they find in their net after having paid for the catch (or having obligated themselves to pay for it). Despite this, it sometimes comes to pass that a lead buyer has inadvertently cast too wide of a fishing net when formulating his or her bidding profile and then the buyer discovers upon closer inspection of the detailed features of certain ones of the leads that the buyer has paid for (or obligated him/herself to pay for) one or more leads that they are of no use or little value to the buyer.

It is desirable to keep as many buyers as possible happy with the results they find in their daily fishing nets (so to speak) when using a leads trading system so that they will be motivated to continue to participate in the trading process and by such participation, they will thereby provide sellers with a wider marketplace into which to sell their offerings (namely, the sourced leads). An automated marketplace is disclosed herein that integrates bid-and-buy features with ask-and-post features in a novel arrangement.

### SUMMARY

Structures and methods may be provided in accordance with the present disclosure of invention for improving over the above-summarized shortcomings of automated lead trading or other informational item trading systems and also over the shortcomings of the above-described, fixed ping-and-post process. It is to be noted that the present disclosure need not be limited to the automated pricing and dispensing of leads and that it may be viewed more expansively as relating to the pricing and dispensing of other types of informational items whose detailed content is often hidden from the buyer until he/she obligates him/herself to paying for the informational item. In general, an integrated hybrid system has been developed that automatically provides bid-and-buy services in combination with subscribable-to, ask-and-post services. In one embodiment, a lead buyer may elect to not subscribe to the ask-and-post services in which case the system appears to that buyer as a basic bid-and-buy system. The term, ask-and-post is to be taken as being different from ping-and-post at least because an ask-and-post system does not necessarily step blindly down a fixed ping list having a fixed order and fixedly named buyers. In one embodiment, the determination as to which bidder/buyer (or group of bidders) gets asked first in an ask-and-post manner is a stochastic one with various factors feeding back into the determination of probability of being asked first for each of competing buyers/bidders. Thus, in that embodiment, it is often the case that no subscribing bidder is forced into always being last on a ping list and into never having a chance to be the first one asked in an ask-and-post manner regarding the option of acquiring a lead that is subject to ask-and-post previewing. In an alternate embodiment, the determination as to which bidder/buyer (or group of bidders) gets asked first in an ask-and-post manner (or gets asked in a blast-ask and re-auction manner) is a deterministic one with various factors feeding back into the determination of which individual (or group of individuals if blast mode is true) will be first given an ask-and-post opportunity where some of the feedback factors deterministically punish undesirable behavior by ask-and-post subscribers and/or deterministically reward desirable behavior (i.e., behavior within allowed tolerances) by ask-and-post subscribers.

A method that may be carried out in one embodiment comprises: (a) assigning a lead to a virtual auction bin, (b) dynamically sorting bidders who participate in that bin according to a stochastically and/or deterministically determined first order, for example, listing them from highest scoring bidder to lowest scoring bidder where for the case of the stochastically determined first order, the highest scoring bidder is often, but not always, the highest bidding one for the given lead and the lowest scoring bidder is often, but not always, the lowest bidding one for the given lead; (c) defining the highest scoring individual bidder at the top of the first scoring order as the current winner or defining an upper group of plural bidders as potential winners; (d) providing opportunity for a partial closer peek or a full preview of additional details in or about the lead to the current top individual bidder or to the upper group of bidders; (e) giving the bidders who have access to the closer peek a timed right of first refusal to either indicate acceptability of the lead that he or she has initially been awarded an opportunity to preview in more detail or to reject it after having been given such an opportunity for a partial closer peek or a full preview of details; (f) upon the current individual or top group of closer peekers all rejecting the given lead or timing-out on the allotted closer peek right, moving down the dynamically ordered list and defining the next highest scoring individual bidder or group of plural bidders as potential winners and giving him/her/them a similar timed right of next preview and refusal; (g) continuing down the list until exhausted or until a close-peek previewer accepts the offered lead after having been provide with the opportunity for a partial peek or a full view of the details of that lead. The method thereby allows bidders to take a closer look at what has been caught in their bidder's net before accepting (or indicating acceptability) and thereby potentially obligating themselves to pay for it. It allows bidders lower down the scoring chain to have an opportunity to accept a lead that has been rejected by one or more bidders higher up on the ask-and-post chain. The stochastic nature of one dynamic ordering embodiment allows bidders who have limited financial resources and who therefore often bid low on offered leads to nonetheless have a chance to once in a while win the lottery, so to speak, and thus such bidders with limited financial resources are still encouraged to participate in the marketplace on hopes of winning a bargain every once in a rare while. In one embodiment, a so-called blast mode group of plural bidders is automatically formed and rather than sequentially presenting the sneak peek opportunity to them on a one at a time basis, a blast-ask and re-auction opportunity is simultaneously transmitted (e.g., multicast) to the whole group of subscribing bidders. Bidders who receive a blast-ask can all look at the sneak peek on a substantially simultaneous basis and elect to reject or accept with their current bid or accept with a raised or lowered bid. In this blast mode context, an acceptance does not yet mean that the bidder is bound to pay for lead. An accepting bidder may still fail to win in the second round contest or timed cut for the lead. Instead, an acceptance in the blast mode context means that the bidder is obligating him or herself to the outcome of the subsequent contest (or a multi-award process) and obligating him or herself to pay for the lead if the bidder wins in the subsequent contest/multi-award process (with possibility of a later refund if it turns out to be a defective product for example). In one embodiment, those bidders who accept the blast ask proposal with or without a post-ask raise of bid or lowering of bid, enter at least a second bidding round (stochastic or deterministic) and the highest scoring one (as scored by a second stochastic or deterministic auction) is awarded the lead. In the same or another embodiment, a highest listed plurality of K bidders are simultaneously awarded the lead and it is left to the fastest one of the K multi-award group to reach the consumer first.

A second method that may be carried out in the same or another embodiment comprises: (a) causing a bidder's computer to obtain a partial closer peek or a full view of details in, or more details regarding, a lead that has been bid on beyond information provided from having successfully bid on the lead; (b) causing a bidder's computer to analyze the partial peek or full view and to automatically assign a first sneak peek score to it, and/or to present all or some of the partial/full sneak peek details to a human analyzer for second scoring; and (c) causing the bidder's computer to determine based on the cumulative sneak peek score whether to accept or reject the lead, and if blast mode is active also whether to increase, decrease or leave as is the current bid amount if the decision is to signal contingent acceptance of the lead. The second method may further include the step of (d) causing the bidder's computer to automatically generate one or more instructions or follow-up links based on said cumulative sneak peek score where the instructions and/or links indicate how the lead is to be subsequently processed (e.g., what next URL the consumer is to be guided to) in case the lead is accepted and won. As mentioned, in the case where the ask-and-peek transmission is of a blast-ask type (one involving simultaneous transmissions to plural bidders with simultaneous opportunity to peek at the closer details), the method may include: causing the bidder's computer to determine based on the cumulative sneak peek score not only whether to signal contingent acceptance of the lead but also to further signal a score-driven modification amount (which could be zero) for the bidder's current bid amount based on the assigning of a relatively high, median or low sneak peek score to the blast-ask transmission.

It is to be noted that the term, sneak peek, may be used herein to refer to the larger concept of providing and/or receiving a partial closer peek or providing/-receiving a full view of details in, and/or more details regarding, an informational item (i.e., a lead) that has been bid on at least once where the partial/full peek provides information beyond initial information that may be extracted by a given bidder/buyer from that bidder/buyer having successfully once bid on the informational item. (In one embodiment, the initial information that may be extracted by each bidder/buyer is generally different because each such bidder/buyer can have a different bidding profile and successful bidding indicates that the informational item has fallen within the specific filtering net cast by that bidding profile.) Unless otherwise stated, the term, closer peek, also refers to this underlying concept.

Other aspects of the disclosure will become apparent from the below detailed description.

### DESCRIPTION OF THE DRAWINGS

The below detailed description section makes reference to the accompanying drawings, in which:

FIG. 1 is a block diagram of an automated leads trading system that provides bidders with pre-acceptance partial or full views of their initial winnings and allows the bidders to throw back those of the inspected winnings that they don't want;

FIG. 2A is a combined schematic and flow chart for illustrating how sneak peek privileges to a given lead may be processed in a stochastic auctioning system and also in an individual bidder's machine;

FIG. 2B is a continuation of FIG. 2A which shows how a blast-type ask and re-bid or multi-award operation may be integrated with the sequential mode operations of FIG. 2A;

FIG. 3A is a flow chart illustrating a system for managing bidders with slow reaction times and/or an excessive number of ask-and-post time-outs;

FIG. 3B is a combined graph and data flow chart illustrating some factors that may contribute positively or negatively to a given bidder's chances of winning a current auctioning or bidding round;

FIG. 3C is a flow chart for illustrating how stochastic auctioning may be affected by good and/or bad behavior patterns of a bidder who subscribes to sneak peek services;

FIG. 4 is a flow chart of a subscription evaluation process that may be carried out in a bidder's machine; and

FIG. 5 is a flow chart of an evaluation process that may be carried out in a bidder's machine in response to receipt of a sneak peek transmission.

### DETAILED DESCRIPTION

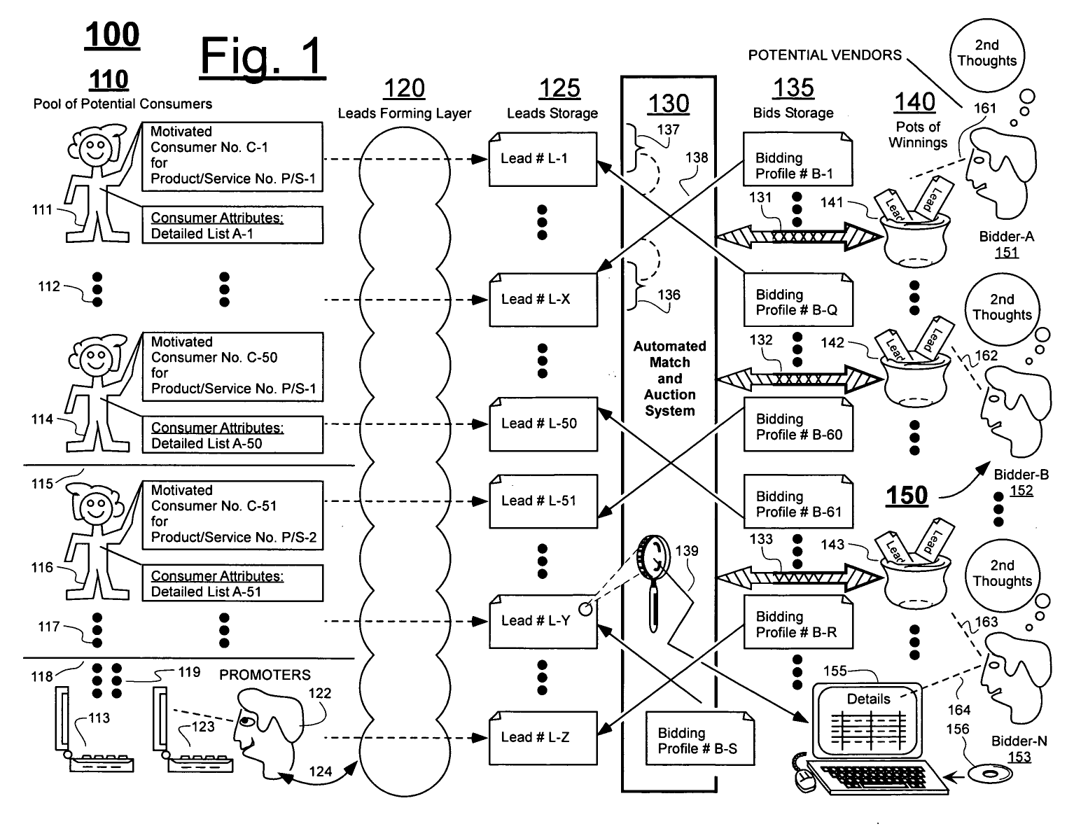

FIG. 1 is a block diagram of a leads trading system 100 in accordance with the present disclosure. Scanning the drawing from left to right, the following processing or storage layers are shown in columnar form: (a) a consumers layer 110, (b) a leads forming/capturing layer 120, (c) a leads storage layer 125, (d) an automated matching and bid managing system 130 (supervisory system) that matches active leads in layer 125 to active bidding profiles in storage layer 135 and offers the leads to successive individual bidders (or to blast mode groups of bidders) in accordance with one or more methods disclosed herein, (e) the aforementioned storage layer 135 for bidding profiles, (f) a storage layer 140 for holding initially won leads (some of which leads may be tossed back into the match and bid managing system 130 if found to be undesirable upon closer inspection), and (g) a bidders layer 150. Also embedded in FIG. 1 is a promoters' layer which is represented by icon 122.

More specifically and with regard to layer 110, the pool of all practically reachable consumers for each given good and/or service (the product) may be segmented in any of a variety of ways depending on product, price range and/or other context setting parameters. The context-setting parameters may include, but are not limited to: (a) the associated class or range or mixture of products involved in a transaction that is sought to be consummated (e.g., sale of automobile alone or with a financing service package); (b) the price range of the product bundle; (c) the longevity and/or urgency of the lead, meaning how long the prospect for closing a deal remains viable (e.g., must be done within seconds because it is a “hot contact” or it may be handled in a day, a week, 3 months, a year, etc.); (d) the geographic location of the prospective consumer and/or of the product (e.g., especially if the product involves a legal interest in real estate); (e) the financial well being of the prospective consumer (e.g., credit rating); (f) the motivation of the prospective consumer to soon close the deal; and so forth. Given this, each prospective consumer (i.e., 111) may be viewed as having a unique identification (i.e., consumer number C-1) and a corresponding product(s) and/or service(s) package which the identified consumer is associated with (i.e., P/S-1). Each prospective consumer (i.e., 111) may be viewed as having further attributes that are listed or list-able in a corresponding attributes list (i.e., attributes list A-1) where those additional attributes may include informational items such as, but not limited to: acceptable price range, desired price range, acceptable quantity of goods/services to be acquired, desired quantity of goods/services to be acquired, and various ones of the other attributes listed above as context-setting parameters. Depending on context, some of the consumer's attributes (i.e., in list A-1) may be more critical than others to various ones of the bidders on the other side of the system in layer 150. For example, if the contemplated transaction involves real estate located in a particular geographic area and the potential vendor (i.e., represented by bidder 151) is not licensed to handle such real estate, then the bidder of that vendor should not be bidding on a lead to the corresponding consumer 111 and some filtering means should be included in system 100 for preventing bids on behalf of unqualified vendors. In one embodiment, such filtering is provided to a certain degree of resolution by the bidding profiles 135 wherein the profiles specify what geographic areas are acceptable and/or which are not.

This example of bid profiles that specify acceptable geographic areas may be used to provide an example of a situation where a bid profile casts too wide of a fishing net (so to speak) and it is advantageous for a winning bidder to have a sneak preview of one or more details within the consumer's attribute list (i.e., A-1) and a right of refusal before the bidder becomes obligated to pay for the lead. Suppose bidding profile B-1 belongs to bidder 151 and the profile indicates a desire for a match up with any consumer who, among other things is looking to buy a house located in the state of California within the next 2 months where the property in question is initially priced in the asking range of say, $300,000 to $999,000 (where the realism of this example may vary after the present disclosure is published). Suppose however, that there are a few certain small towns in California which the bidder refuses to deal with; including for example Eureka, Calif. Suppose the profile (B-1) does not allow for an exceptions listing of such fine detail (such fine resolution); it only allows the bidder to specify one or more states in the United States and that's it. If bidder 151 bids on and wins a lead connecting him with consumer 111 only to learn afterwards that consumer 111 wants a house in one of those few small towns (i.e., Eureka) that are unacceptable to bidder 151, the bidder will usually be unhappy with the fact that he paid money for a lead (i.e., L-1 in layer 125) that is of no value to him. The consumer 111 will usually also be unhappy with the fact that he or she spent time communicating with bidder 151 only to discover that bidder 151 refuses to handle real estate located in the given small town of interest. This is an example of a system failure. Multiple parties will have had a negative experience with the system and will be de-motivated from using the trading system in the future.

Conversely, there may be certain location details which let the lead purchaser know quickly that he definitely wants to purchase the informational item, for example if the house is located in a relatively wealthy neighborhood (i.e., Beverly Hills, Calif.) where this location is very much acceptable to the bidder 151. Additionally, there may be certain timing constraints which can affect the bidder's attitude towards the lead after seeing its details (or details abstracted from the lead). For example, the bidder may be too be busy at the moment to handle a real estate property that has to close in the next two months (the time window that this exemplary consumer insists on) and as such the bidder will not be able to help the consumer once that detailed piece of information becomes known. Conversely, the situation may be the exact opposite where the bidder is not at all busy at the moment and very much wants to handle a real estate property that will probably close within the next two months. Accordingly, desired timing of purchase and/or desired speed of delivery may be examples of higher resolution timing details. Additionally, there may be certain personhood details which can affect the bidder's attitude towards the lead after seeing its details (or details abstracted from the lead). For example, the bidder may not wish to do real estate transactions with consumers whose average yearly income is less than $100,000 and/or whose public credit rating is below a certain predefined threshold. If the bidder was to obtain this kind of detailed personhood information about the prospective consumer before the bidder purchased the lead, both the bidder and the consumer would be better off because neither would have wasted time later to uncover that deal-killing piece of detailed information and to then be disappointed by the inability of both to successfully close on the transaction.

In addition to, or as an alternative to higher resolution details provided by a sneak peek regarding location, timing and/or personhood, a sneak peek may provide higher resolution details regarding the product/service which the prospective consumer seeks. Such higher resolution details regarding the product/service may include, but are not limited to: (a) a more specific price range that the consumer is interested in; (b) more specifics regarding attributes of the sought product/service such as, if it is a loan, whether the loan is to be fixed, adjustable, zero amortization and so on or such as, if it is a tangible good like shoes, the quantity range (i.e., how many pairs are) being sought by the prospective consumer and what style or styles (i.e., women's shoes, flat heel versus high heel, etc.) are being sought and/or what model numbers would or would not be acceptable to the prospective consumer.

In accordance with the present disclosure, after initially winning a bid on lead L-1, bidder 151 is given an opportunity for a full or partial view (161) of some or all details in or about the lead L-1 (i.e., location to a greater degree of resolution, timing window to a greater degree of resolution, personhood information to a greater degree of resolution and/or other information to a greater degree of resolution) and the bidder is then given the ability to indicate something to the effect of: “The small town (i.e., Eureka) which this consumer 111 wants is one of the few exceptions to the wide geographic area of California specified in my profile B-1 and indicated to be acceptable to me; and because of this unusual exception to the rule, I am refusing delivery of this lead even though it fits my broad profile and I have bid on it and have won the bidding round.” (It is to be noted that in one embodiment, bidding or auctioning is a stochastic process and the highest bidder does not always score highest in a given bidding or auctioning round.) The system 100 allows the sneak-peeking bidder 151 to then send an indication of rejection or return, or to actually return an already delivered lead from his winnings bucket 141 (a virtual bucket) back to the match and bid managing system 130 by way of transmission path 131. In response, the match and bid managing system 130 may place the rejected lead up for bid by the remaining bidders; or alternatively, since a bidding round has already been executed, the supervisory system 130 may offer the rejected lead to the next highest scoring bidder, i.e. 152 of the already executed round. The match and bid managing system 130 gives the next in line bidder (the one with the next highest scoring for the same lead, and assuming that next bidder has sneak peek privileges) a chance to preview (162) details of the same lead and to accept or reject the lead in the same way that bidder 151 did. This down-the-chain mechanism of granting closer inspection rights and allowing each successive inspector (i.e., 152) to accept the lead or allow the acceptance opportunity to pass down to the next bidder in a computer-generated ordering line (e.g., a stochastically generated line) provides users of the system (bidders 150 and consumers 110) with an enhanced experience as compared to the situation where a bidder is forced to accept delivery of a lead (and forced to pay for it) even though on closer inspection the first bidder realizes he cannot properly service the lead. In one embodiment, system 100 is actually a hybrid of an ask-and-post system and a stochastic match-and-bid system since some bidders may elect to not subscribe to ask-and-post services and may deal with the system as bidders who do not get sneak peek privileges (and who do not get the burdens associated with being eligible for sneak peek previews). Although determination of a bidding contest is often spoken of herein in terms of a stochastic match-and-bid system, it is within the contemplation of the disclosure to alternatively use a fully or partially deterministic selection system wherein the winner of a bidding contest is found completely or at least partially on the basis of a deterministic algorithm rather than on the basis of a stochastic process. The fully stochastic process gives low-bidding bidder a lottery type chance of winning on occasion even if they are low bidders and thus such a stochastic process encourages a wider population of bidders to participate. However the ask-and-post aspects disclosed herein may be practiced under the auspices of a fully deterministic selection system if that is how the operators of the match-and-bid system wish to operate their system for a given one or more product lines or for all bid-upon product lines.

For purpose of completeness, column 110 is more fully described. Consumer 114 is yet another one who is seeking to acquire a product/service package identified as P/S-1. Consumer 114 has his or her own unique identification (i.e., C-50) and unique set of attributes as set forth in detailed listing A-50. Ellipses 112 represent a spectrum of yet further consumers belonging to a common group of consumers 111 and 114 where all are seeking the same product/service package identified as P/S-1 (where P/S-1 can be a range of interrelated goods and/or a corresponding range of interrelated services rather than just one specific good and/or service) but where each of the consumers represented by ellipses 112 can have his or her own unique identification/attributes (i.e., C-2 to C-49 and A-2 to A-49). Among the bidders population 150, there should be a first subset of bidders who are interested in servicing the needs of consumer population 111-112-114. The first subset of bidders indicate their willingness in their corresponding bidders' profiles 135 by specifying product/service package P/S-1 as a package they are bidding on. Each bidder can bid a different amount based the bidder's own economic interests. Each bidder can further specify in his profile, certain broad filtering requirements such as geographic region (i.e., California and/or large counties thereof), price range for the product/service package, number of units (i.e., wholesale versus retail) and so forth. However, as indicated above, there is a predefined limit to the resolution of the filters provided within the bidders' profiles. Thus for example, a bidder may only be able to specify down to the state or county level but not to the point of identifying every tiny town they refuse to do business in. As such, a bidder's profile may inadvertently capture a significant number of leads that the bidder (or corresponding vendor) is unwilling to deal with.

Separation line 115 represents the boundary of a next population 116-117 of consumers seeking a different product/service package denoted as P/S-2. Same individuals or other consumer entities may appear on a non-mutually exclusive basis in population 111-114 and in population 116-117 where the difference is they are seeking different product/service packages when participating in the different populations of potential consumers. Typically, a same consumer will be given a different unique identification (i.e., C-51 for person 116) by the system 100 so that the system can differentiate between every separate consuming activity undertaken by the given consumer. (Also a same consumer can have different unique identifications depending on which promoter 122 sponsored that consuming activity. However that is a feature of minimal relevance here.)

Separation line 118 represents the boundary for yet a next population 119 of consumers. Persons or entities known as promoters (or sponsors) 122 are given responsibility for encouraging consumers 110 to engage with the leads forming/capturing layer 120 layer of the system 100. Typically, the promoters/sponsors 122 expect to get paid for their promotion activities (123). Details regarding that aspect are disclosed in the above-cited applications, but are of minimal relevance here.

Although FIG. 1 shows the pool of consumers 110, pool of bidders 150 and the promoters 122 as being people, it is to be understood that each of these actors can be an automated actor or automated agent acting on behalf of a responsible person or on behalf of another responsible legal entity rather than being an actual person. It is further to be understood that some form of telecommunications apparatus and/or computing apparatus (instructable machine) is associated with each of these actors. Each consumer may interact with the system by way of a simple touch tone telephone if desired. More often though, each consumer will be interacting with the system 100 by way of a respective, consumer's computer 113 (only one shown) where that consumer's computer 113 is appropriately programmed and can take any of a variety of forms from a desktop unit connected by cable to the internet to a laptop with wireless coupling to a network or an intelligent combination cell phone and personal digital assistant device (PDA) such a Blackberry™ or the like. (The Blackberry™ is currently popular handheld computer/-telecommunications device available from the RIM Corporation of Canada.) Each consumer 111-119 will typically use their corresponding telecommunications apparatus and/or computing apparatus (including software) to navigate via one or more communications channels (i.e., web sites) so as to make contact with the leads forming layer 120 and/or with a promoter 122 who then interacts with the leads forming layer 120 on behalf of the consumer.

Each promoter 122 may similarly interact with the system 100 by way of a simple touch tone telephone if desired. More often though, each promoter will be interacting with the system 100 by way of a respective, promoter's computer 123 (only one shown) where that promoter's computer 123 can take any of a variety of forms from a full server farm and/or plurality of desktop units connected by cable(s) to the internet to laptops with wireless couplings to networks or an intelligent combination cell phone and personal digital assistant device (PDA) such a Blackberry™ or the like and can have appropriate software loaded therein. The promoters may use their computing and telecommunication devices not only for interacting with potential consumers 110 but also (or alternatively only for) creating consumer attracting content that attracts prospective consumers to web sites or to making phone calls or to initiating contact with the system 100 in some other way (i.e., even writing an old fashion letter or sending in a post card indicating interest).

One aspect of the leads forming/capturing layer 120 layer is that there are different kinds of leads; most notably there are those that can be characterized as “hot contact” leads versus those that are of a cooler nature. An example of a cooler lead is an interest post card mailed in by a consumer and filled in with handwriting to indicate the consumer's contact information. That consumer is not expecting an immediate reply back. On the other hand, a consumer who dials a telephone number associated with a call-us-now/operators-are-standing-by advertisement will be expecting immediate service and thus will usually be classified as a hot-contact consumer. Hot-contact transactions may include transaction situations that have a potential, and possibly impatient, customer (i.e., 111) hanging on in a live-time telephone connection or on a like other voice and/or video connection waiting for a human transactor (e.g., a telephone operator, chat room operator) to pick up the call and/or other live-but-on-hold link and conduct a desired business transaction with the consumer (i.e., to negotiate purchase of N units of P/S-1). It is desirable for a human transactor to pick up the waiting connection in a matter of few seconds or minutes (e.g., less than 2 minutes) so as not to risk losing or offending the customer. After the transactor (e.g., telephone operator) finishes with a first on-the-line live interaction, it is often desirable for the transactor (e.g., telephone operator) to move on quickly to picking up and processing a next awaiting live call and so on. Time wasted between incoming calls is generally detrimental to operation of the system 100 because many other consumers (i.e., 114-119) can be on hold waiting for their turn. As such, it is particularly important in the hot-customer/transactor market space for the turn-around time to be relatively short (i.e., less than 2 minutes or better yet less than 30 seconds) between initiation of contact with or by the consumer and final awarding of a lead to a bidder where the bidder (or an agent thereof) then immediately picks up the live communication channel and continues interaction with the consumer (i.e., 111) or immediately calls back. Various techniques are disclosed in the above cited applications for making the process of collecting detailed information (i.e., A-1 through A-51) from the consumers appear as seamless and simple as possible so that the consumer is not dissuaded from continuing by being immediately shown long reams of application forms to fill out. For example, the consumer may have been browsing the Internet and may have been attracted to a promoter's web site that showcases a particular product/service. The browsing and web-navigating activities of the consumer may already have given away his or her geographic location and other demographic information. So that information is automatically collected and recorded into the data item that will become the lead (i.e., Lead #L-1) without twice asking the consumer for the already garnered information. If the consumer calls from a telephone that allows for caller-identification, the telephone number of the consumer will have been automatically collected and recorded for incorporation into the data item that will become the lead (i.e., Lead #L-1). The area code of the collected telephone number will usually allow for automatic determination of the specific geographic location where the consumer lives or works. This is the detailed kind of information that promoters/lead sellers 122 do not want to immediately show to bidders/lead buyers 150. However, if bidder 153 for example gets a pre-purchase preview 164 of such details and discovers that prospective consumer 116 (for example) is calling from Eureka, Calif., then in accordance with the present disclosure bidder 153 may refuse that lead (i.e., Lead #L-51) and return it as un-purchased (or for full or partial refund) to system 130.

Each bidder (i.e., 153) will typically interact with the system 100 by way of a respective, bidder's computer 155 (only one shown) where that bidder's computer 155 can take any of a variety of forms from a full server or server farm and/or plurality of desktop units connected by cable(s) to the internet to laptops with wireless couplings to networks or an intelligent combination cell phone and personal digital assistant device (PDA) such a Blackberry™ or the like with appropriate software (e.g., 156) loaded in. A bidder may occasionally even interact with the system 100 by way of a simple touch tone telephone if desired with assistance of voice activated menu control. Bidders 150 typically use their computing and/or telecommunication devices for forming their respective bidding profiles 135—in essence defining the breadth of the fishing nets they are casting to the extent of resolution allowed by the match and bid system 130 and setting the price per lead that they are bidding for each lead that might be caught in their net. FIG. 1 represents two such nets as bracketing icons 136 and 137. Bidder-A (151) may have for example formulated one of his corresponding profiles, #B-1 to cast a net 136 (via action 138) that captures Lead # L-x in its scope (i.e., all of California, all refinance deals in the market value of $300,000 to $999,000, bid amount for each lead=$3.00). Bidder-B (152) may have for example formulated a corresponding one (#B-Q) of his profiles to cast a net 137 that captures Lead # L-1 in its scope (i.e., just real estate in the Los Angeles county portion of California, all refinance deals in the market value of $500,000 to $1,999,000, bid amount for each lead=$5.00). Similarly, Bidder-N (153) may have for example formulated his corresponding profiles (#B-R and #B-S) to cast respective nets that capture Lead # L-Y and Lead # L-Z in their scopes.

Another function that may be performed in each bidder's computer (155) is to provide reports for keeping track of the total winnings (won leads) in virtual bucket 143 for a given time period such the hour or day and for keeping track of how much was spent for those winnings and for keeping track of how large of a transaction was consummated (converted) or not for each won lead. In this way, the bidder is able to keep track of the efficiency of his or her lead trading activities.

One factor that can negatively impact lead trading efficiency is that of casting too wide of a net and capturing too many unwanted leads at the boundaries (linear algebra edges) of such overly-wide fishing net. However, another factor that can negatively impact lead trading efficiency is that of casting too narrow of a net and missing highly lucrative leads that would have otherwise been caught at the hypothetical peripheries (linear algebra vertices) of a hypothetically larger net. So as between the two options, bidders would prefer to err on catching too much and being able to throw some back rather than missing out on some more lucrative deals (i.e., a real estate that is just outside the outskirts of the Los Angeles county portion of California, but has a market value of $1,999,000—the high end and more lucrative edge of that vendor's acceptable range).

A system in accordance with the present disclosure allows a bidder (i.e., 153) to enjoy the best of both worlds. He can cast a fishing net (actually a bidding profile, i.e., Profile #B-S) that spans a range slightly larger than what he would automatically be comfortable with (i.e., to include the outskirts beyond Los Angeles county for example) and he can ask the match and bid system 130 to provide him with an advance look 163-164 at one or more details of a filtered one or all of his leads prior to being obligated to pay for them. In this way he can keep those of his fringe catches that are lucrative but elect to toss back (via path 133) those of his initial winnings 143 that are of no or little value to him, thereby increasing trading efficiency. Typically, the bidder will automatically accept initial winnings that are at the center of his net but will want to take a closer look (either manually and/or automatically by means of automatic scoring) at those of his initial winnings that are closer to the fringe edges of his cast net.

In one embodiment, the bidder's computer (or other instructable machine) 155 will include manufactured machine instructions 156 (i.e., those loaded in from tangible media and/or transmitted as manufactured instructing signals over a network) that cause the bidder's computer 155 to automatically perform various tasks such as subscribing to, and/or negotiating for, the right to see certain, earlier withheld details concerning a bid-upon lead, and if the rights are obtained, fetching such details (via path 139) regarding an initially won lead (i.e., #L-Y) prior to the bidder becoming finally obligated to accept and pay for that lead. The earlier withheld details can include detailed information extracted directly from the lead item itself and/or the earlier withheld details can include additional information that is abstracted by the match and bid system 130 from the lead item or elsewhere and which additional information the bidder could not have obtained merely from knowing that his profile (i.e., #B-S) matched with the lead. The bidder's machine 155 will typically also include software for automatically analyzing the sneak peek details and for producing a sneak peek decision score indicating a value of the lead to the bidder based on analysis of those details, and for automatically accepting the lead and/or automatically displaying one or more of the details for manual review 164 by the bidder and for manual approval or rejection thereof by the bidder prior to signaling an accept or reject decision to the match and bid system 130.

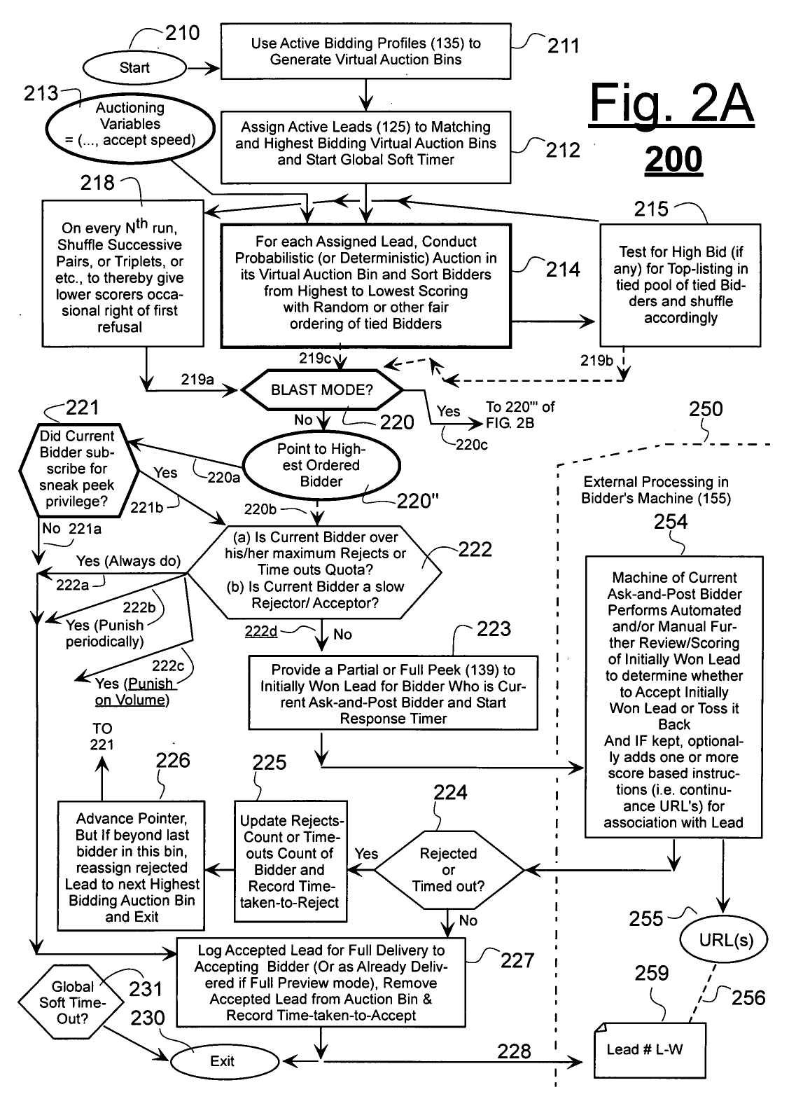

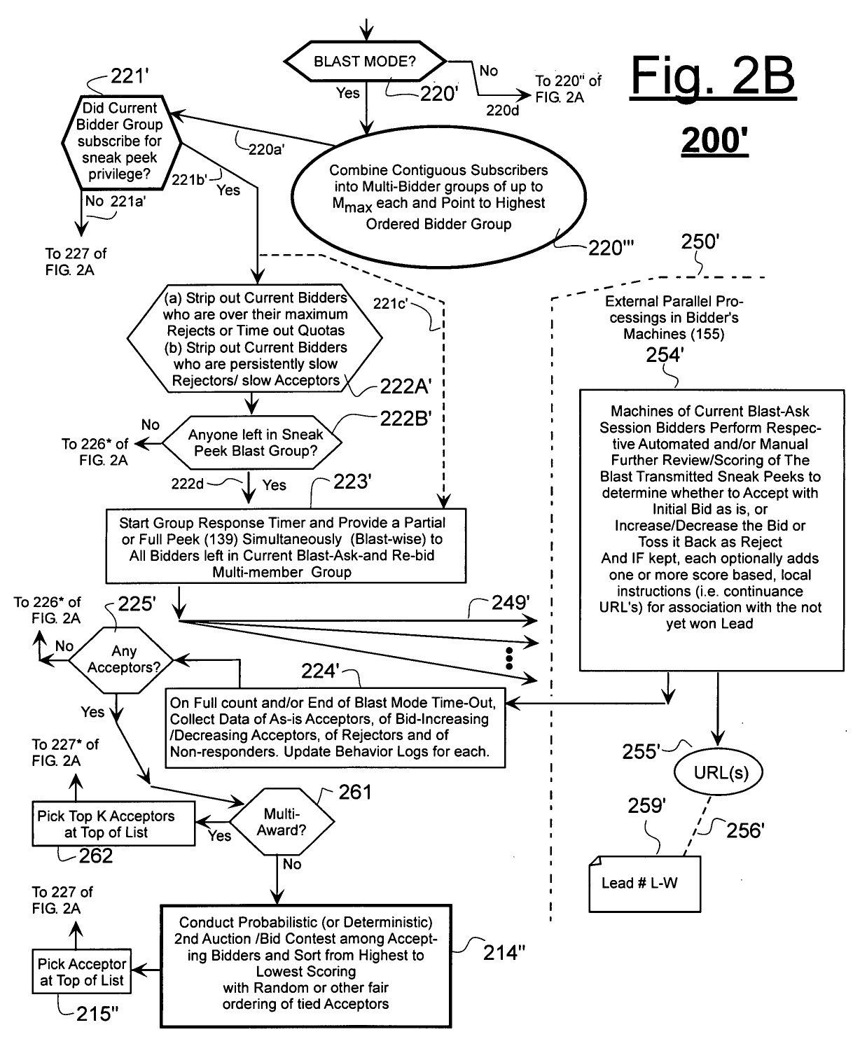

The right to preview initially withheld details concerning a bid-on-lead (i.e., #L-Y of column 125) and to inspect such details more closely (functions 139, 164) and to have second thoughts about the lead before assenting to becoming legally bound to pay for the lead should not be handed out for free to all bidders (150) because the system 100 incurs a throughput penalty in allowing bidders to have such sneak peeks (161, 162, 163-164) and in allowing the bidders to return for full refund (or partial refund) those of their initially won leads (141-143) that the bidders decide on second thought they don't want after having taken a closer peek (161-164) at details concerning the lead. It takes time and consumes system resources (system bandwidth) for transporting the sneak peek signals (i.e., 139) to the respective bidders (i.e., 153). It takes time for bidders and/or their computers (i.e., 153, 155) to receive the sneak peek signals (i.e., 139) and/or signaled invitations to receive the sneak peek signals and to process them (i.e., score the sneak peeks manually and/or automatically) and to send back their decision indications (i.e., via channel 133) as to whether they will accept or reject those leads. It also consumes system bandwidth when bidders and/or their computers fail to respond to the invitation to receive the sneak peek signal or to respond to the sneak peek signal itself with an affirmative rejection in which case the system 100 may waste a predefined one or more time outs. Also, the bidders' machines 155 have to be appropriately programmed to handle sneak peeks (and optionally invitation signals which invite the bidder's machine 155 to indicate back that the machine wants to receive a sneak peek transmission). In some cases, bidders behave badly by not signaling their accept/reject decisions to the control system (i.e., 130) or by taking an excessive amount of time to do so. All the while, other actors that are using the system 100 (i.e., promoters 122, other bidders 151-152, and/or consumers 110) may be put on hold and/or otherwise inconvenienced from having to wait for a given bidder (i.e., 153) to make up his mind or for a time-out watchdog timer to run out of time. It will be seen shortly (in FIG. 2A) that in one embodiment, one or more means are provided for disciplining and/or weeding out bidders who abuse the sneak peek providing system by for example not affirmatively responding to invitations for, or to the sneak peek transmissions themselves within a system allotted time. Moreover, it will be seen that in one embodiment, sneak peek privileges (subscriptions) are not handed out freely and instead bidders are forced to pay for the privilege (and/or to otherwise subscribe for the privilege and agree to certain preconditions, see box 221 of FIG. 2A) before being given it. It will be seen that in one embodiment bidders are forced to bid on the value of a sneak peek (see box 215 of FIG. 2A) during a given machine-mediated contest thereby establishing its value in an open market bidding style during that contest. In another embodiment, ask-and-peek operations are run on a blast mode basis as shall become clearer when FIG. 2B is described.

Before moving on to the details of FIG. 2A, it should be noted that in FIG. 1 the sneak peek option (164) can be most detrimental in the case of a hot-contact transaction where, for example, a consumer 116 has been placed on hold in a live telephone conversation with a first operator (122) or with an automated voice-recognizing questioning system (not shown, but embedded within leads forming/capturing layer 120) and where that consumer 116 is waiting for a specialist operator (i.e., 153) to very soon pick up the live call and continue dialogue with that consumer. Accordingly, in one embodiment, the penalties charged or quotas set for slow responding bidders are substantially stiffer for the case of hot-contact leads as opposed to those of cooler contact leads (i.e., one where a consumer is waiting for reply back via an email message or a return phone call on a subsequent day rather than for a live-time response of relative immediacy). In one embodiment, blast mode parallel-ask and parallel-peek operations are used in the case of hot-contacts so as to thereby minimize the wait time of on-hold prospective consumers. (Such blast mode operations will be explained with reference to FIG. 2B after the simpler to understand, sequential operations of FIG. 2A are explained.)

Referring then to FIG. 2A, the illustrated flow chart applies to a multi-processor environment 200 including a match and bid system server (130) and a bidder's computer (i.e., 155) that is operatively coupled to the match and bid system server. An auctioning (or bidding) round begins at step 210. At this stage, one or more bidders 150 have each formulated one or more bidding profiles (135) and activated those profiles for participation in the given round of bidding or auctioning for a specified type of informational item (e.g., lead). Typically, each bidder is kept in the blind as to whether and how many other bidders are participating, who the seller (122) is and who the consumer (116) is. The match and bid system 130 automatically establishes a market and sets the price, for example in accordance with received initial bids and a complex re-pricing method that is disclosed in one or more of the above cited patent applications: U.S. Ser. Nos. 11/207,571; 11/373,633 and 11/412,238 (incorporated here by reference). In one embodiment, bidding or auctioning is stochastic process rather than a rigid and guaranteed one (a deterministic one) for the highest bidder. In other words, the highest bidder does not always win. He usually has a higher probability of winning the given bidding or auctioning round than a lower bidder. However, every so often, a next lower bidder wins. And once in a rarer while the lowest bidder in the bidding pool rolls a winning toss of the dice and gets first crack at the lead even though he has the lowest bid among the bidders then bidding for that lead. So there is an element of a sort of lottery built into the system where everyone has a chance of coming up a winner. As a result, bidders who would otherwise be reluctant to bid are encouraged to nonetheless participate in the system, thereby enhancing the level of free market competition. Additionally, in one embodiment, bidders are given discounts for various reasons including in cases where the lead is sourced from a promoter (122) who has a less than stellar reputation with regard to the average quality of leads that this promoter provides.

At the time of step 211, the participating lead bidders/buyers have activated their bidding profiles and in response, the matching system 130 uses the parameter ranges established in those active bidding profiles to generate a plurality of virtual auction bins. For example, one auction bin may define the product/service as loan refinance services for properties valued in the range of $300,000 to $999,000 and the acceptable geographic region as California. All bidders whose profiles cover this broad range may participate in this virtual auction bin. For example, a bidder who specifies his geographic region as Western USA and his property values range as $200,000 to $999,999 would participate in the bidding because his broader fishing net encompasses leads falling into the narrower auction bin.

At step 212, leads 125 that have been received from the leads forming layer 120 are stochastically assigned to those of the formed and matching auction bins, usually to those that have the currently highest set of bids in them but also every once in a rarer while to bins that have lower bids and/or a fewer number of bidders participating in them. In this way each lead is usually routed to the matching auction bin that promises to provide the seller (promoter 122) with the highest possible source of revenue and the largest number of competing bidders at the moment but at the same time, lower bidders in other bins are not completely cut off from getting a chance to bid on part of the lead volume flowing into the system from capture layer 120. If a lead does not sell in its initially allocated bin (e.g., the bin with the highest priced bids and usually the largest number of competing bidders), it is automatically stepped down stochastically usually to the next highest bidding bin and so on.

In one embodiment, when a lead is assigned to a bin, a corresponding, global soft timer is started for that lead within step 212. The purpose of the global soft timer is to make sure the lead does not get lost in an endless shuffle of being reassigned from one of sequential sneak peek offerings to another without the consumer ever being actually contacted and politely responded to. In one embodiment, the global soft timer of a hot contact lead is set to about 60 seconds. If the 60 seconds runs out and there is no ongoing sneak peek running for the lead, a global soft time out interrupt (step 231) takes over for the given lead and pass contact with the lead to a system-operated, soft landing management center. An operator (human or automated) at soft landing management center picks up the still on hold consumer and informs the consumer to the effect that unfortunately no specialist operator has become available to handle the specialized inquiry of that consumer and would the consumer be willing to receive a later call back, and if so when would be a good time. In this way the system avoids placing consumers on hold for excessively long times. The global soft timer is termed “soft” because its timer setting is not a hardened one. If a sneak peek offering is still ongoing for the lead and it is possible the offering will produce a bidder who wants the lead, the system waits for the end of the sneak peek offering time and test for the result of no acceptances before invoking interrupt step 231. If the consumer agrees to a later call back, the corresponding lead is resubmitted into the system as a non-hot one and allowed to percolate further until an interested bidder is found or another soft landing timer runs out. With the exhaustion of the second soft landing timer, the soft landing management center calls back the still waiting consumer and informs the consumer to the effect that unfortunately no specialist operator has yet become available to handle the specialized inquiry of that consumer and would the consumer be willing to receive a call back at yet a later time, and if so when would be a good time.

Following step 212, after various ones of the active leads have been logically assigned to respectively matching auctioning bins and soft landing timers have been optionally started for some or all of the given leads, in step 214 the actual contests (first contests) between the competing profiles (e.g., between the bid amounts in the respective profiles) are conducted and the profiles are sorted from highest to lowest scoring thus placing the highest scoring player (i.e., bidder 153) in the current top spot of each given contest bin for receiving delivery of the given lead. As mentioned above, in one embodiment, the scoring is a stochastic process wherein the bidder with the highest priced bid typically has the greatest chance of winning the highest score and thereby winning the lead, but not always. Every so often, a bidder who has bid a lower amount wins. Thus everyone has a chance, but the chances of higher bidders for scoring highest are usually substantially greater than those of low bidders. By way of a nonlimiting example if there are N buyers bidding in a given bin, then a virtual die with N faces numbered 1 to N on the faces is instantiated. The virtual die is loaded (weighted) differently for each buyer and rolled as such for that buyer/bidder. For example, the buyer with the highest bid amount has the greatest probability of rolling his die to produce N as his score. The buyer with the lowest bid amount has the greatest probability of rolling his die to produce 1 as his score. In an alternate embodiment, step 214 may use a deterministic bidding and re-scoring process in addition to or as opposed to a stochastic process.

The stochastically-run and/or deterministically-run bidding or auctioning round is not based entirely on bid amounts (or in one embodiment, entirely on bid deltas between the various bidders). Other factors can enter the equation to enhance or reduce the probability (or assuredness) that a given bidder will roll a highest score in the current bidding or auctioning round. In cases of tied dice-rolling scores, in one embodiment, the tied bidders are further sorted within their tie pool in accordance with a random order or another fair ordering system (i.e., round robin allocation to the top spot in the tied range). In one embodiment simple path 219c is taken to next step 220.

In another embodiment however, control next passes to step 215 where those bidders whose bids happen to fall within a tied value range are allowed to bid in a second round for moving themselves up to the front of the line within that tied bidding range. One reason why a bidder may want to pay for moving up to the top of his tied heap is because that position gives this bid a better opportunity for getting a sneak peek (139, 164) and a right of first refusal based on the peek (assuming blast mode is not turned on). Bidders may record their bid for moving up to the top of the tied range (if it happens) by specifying such a bid amount within their respective bidding profiles (this bid not being for the lead itself, but for the opportunity to take top spot in a tied pool). If no one bids for moving higher up in the tied range than nothing happens in step 215. On the other hand if one of the bidders has placed the highest bid for moving to the top of the chain, then step 215 reshuffles the order established in 214 accordingly, moving the highest bidder either deterministically or stochastically towards the top of the tied range, the next highest bidder towards the number two spot and so forth. In one embodiment, reordering in a tie pool may be stochastic process similar to that carried out in the actual bidding round of step 214. In one embodiment, control may next pass via path 219b to step 220.

However in another embodiment (wherein process 215 is not stochastic), control next passes to step 218 wherein, despite all the bidding and reshuffling that may have occurred in steps 214-215, on every Nth run (where N is an integer greater than 1, such as 5, 10 or 15) the system reshuffles successive pairs or triplets or so forth couplets of the preordered bids so as to thereby give lower bidders an occasional right of first sneak peek even though they are not as financially well heeled as the highest bidders and thus could not buy their way to the top of the sneak peek pile. This periodic or occasional reshuffling 218 prevents well financed bidders from cornering the market and driving all other bidders out of participation within the market system. If the latter were allowed to occur, then after driving the low bidders out of the marketplace, the well financed, high bidders could then bid lower than what would have been needed in a fair marketplace where more competitors participate. Such a move would deprive promoters (122) of fair, market established compensation for their efforts. Control next passes via path 219a to step 220.

At step 220 the system determines whether blast mode is active or inactive. For sake of following the easier to understand situation first where bidders are asked one at a time rather than by way of a parallel-ask and parallel peek blast mode, it is assumed here that the answer is No and control next passes to the one-at-a-time control step 220″ (double prime).

At step 220″ the system is pointing to the one bidder in the highest spot within the ordered list after one or more of steps 214-215, 218 have been carried out and it has been determined that blast mode is inactive. The identity of the bidder at the top of the heap (or more correctly the identity of bidder's profile at the top) is defined as the current winning bidder. In a simple embodiment, control next passes via path 220b to step 222.

However in a more complex embodiment, control passes via path 220a to step 221 where a first test is conducted to determine whether the current single bidder, as identified by step 220″ (or 226), has paid for a sneak peek privilege or has otherwise subscribed for such a service or privilege. In one embodiment subscription may entail nothing more than registering for free to participate in the sneak peek option. In a more complicated embodiment subscription may include having the subscriber indicate whether or not he or she (or it) is willing to participate in blast mode sessions (FIG. 2B) as well as in one-at-a-time sneak peek sessions (FIG. 2A) or vise versa. During registration, each registrant verifies that their computer system (i.e. 155) is appropriately configured to respond to sneak peek signals (i.e. 139) on a one-at-a-time sneak peek basis and/or on a blast mode basis and to timely respond to such sneak peek offerings. Registration may entail other actions such as having the registrant agree contractually to certain rules of behavior and certain punishments for misbehavior. The specific nature of registration and whether there is a subscription fee or not is left to the control of the system operator and this may vary on the basis of numerous factors including the nature of the product being traded and whether the typical consumer is a hot contact or not. The system operator may also decide whether or under what conditions to invoke blast mode (220). For example, in one embodiment, the system operator may elect to always activate blast mode if the informational item (e.g., lead) is a hot-contact one in need of rapid acceptance and the system operator may elect to always deactivate a multi-award option (261 of FIG. 2B) of blast mode if the informational item is a hot-contact one.

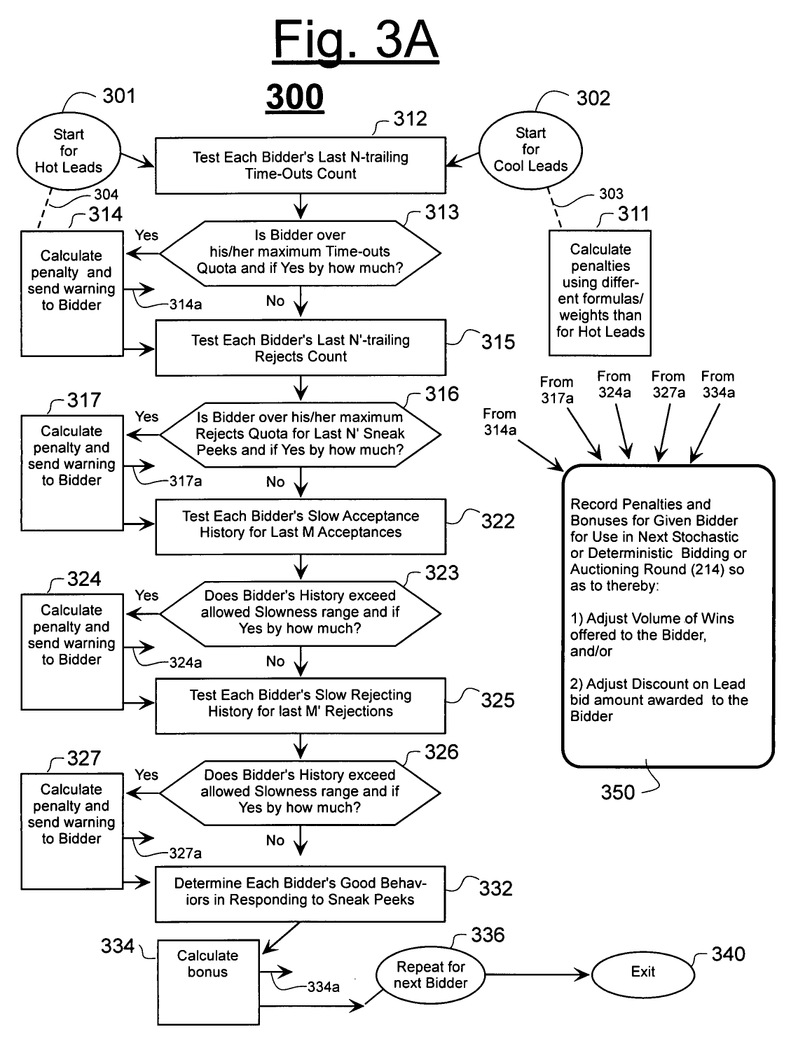

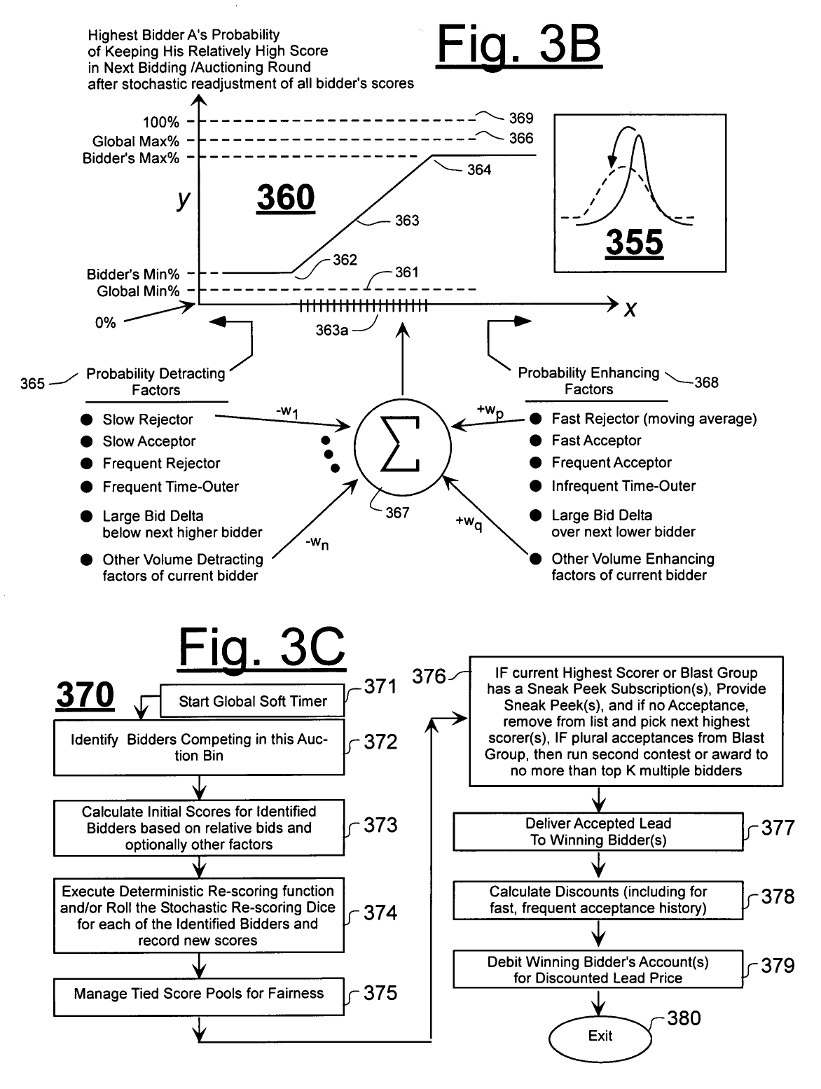

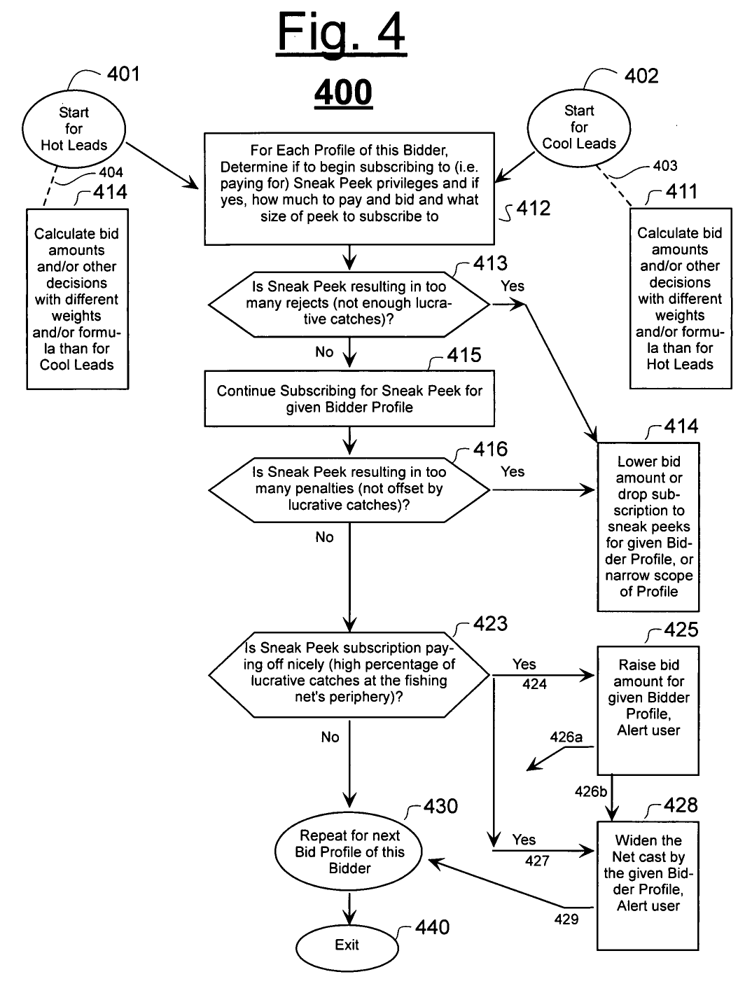

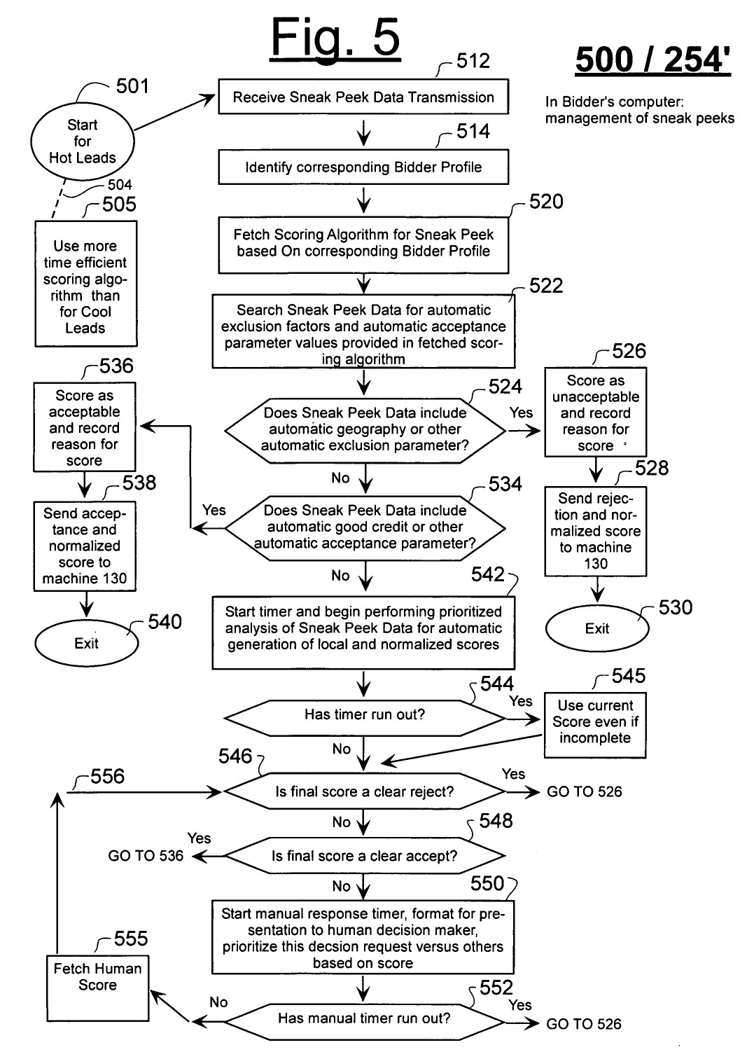

If the answer to test 221 is No, then path 221a is followed to step 227. In step 227 the lead that has been initially won by the current bidder in step 214 is redefined as being a finally accepted lead that is ready for full delivery to the accepting bidder and that lead is removed from the corresponding auction bin. The accepting bidder's account is debited for an amount related to his/her bid. (In one embodiment, this bid amount is augmented by one or more discount factors such as a quality discount that is awarded for example, if the sponsor (122) is deemed to be an inferior one. See also step 378 of FIG. 3C.) The time taken by the bidder's machine 155 to accept in this instance is recorded as being zero. Path 228 represents a corresponding delivery of the full informational content of the respective lead (i.e. #L-W) to the bidder's machine (155) either now or at a scheduled later time (e.g., a batch delivery). The processing for that given lead terminates via exit step 230. The process is reentered again at step 210 when a next new lead arrives in the system and/or new bidding profiles are submitted into the system and activated.

If the answer to test 221 had instead been a Yes then path 221b is followed to step 222. In step 222 one or both of the following determinations maybe automatically carried out in the system server: (a) Determine if the current bidder is over his/her maximum quota for rejects or maximum quota for time-outs, and (b) Determine if the current bidder is defined as being an overly-slow or overly-frequent rejecter; or an overly-slow or overly-infrequent acceptor. If the response to question (a) is Yes (true) then in one embodiment step 222a is followed to step 227. It will be seen below how each bidder may become categorized as being either over or under their quota in terms of rejects or time-outs. If the answer to question (b) is Yes (true), then in one embodiment path 222b is followed to step 227 where the response to a Yes and a traverse through path 222b is taken only periodically or a given percentage of the time rather than always and the percentage of times that path 222b is taken in response to a Yes from question (b) varies depending on how severe a violator the current bidder is with respect to being slow to reject a sneak peek or being slow to accept a lead after having been given an opportunity for a sneak peek at one or more details of the lead. Until he gets a sneak peek, all the bidder knows is that the lead fell into the scope of his fishing net (his bidding profile) but he does not have information of higher resolution. The sneak peek gives the bidder higher resolution information regarding product, location, timing and/or personhood such as indicating that the property value for an adjustable-type refinance service is $455,700 rather than just in the range $200,000-$999,000 and/or that the property is specifically located in San Jose, Calif. rather than just somewhere within that state and that the prospective consumer has a good credit rating and desires to close the transaction within two months. This allows the bidder/buyer to make a more informed purchase decision. But it also may cut into system bandwidth and response speed because now communication channels and processing slots are being consumed for handling the sneak peek operations. As a consequence, in some embodiments, path 222c is taken whereby more egregious offenders who use the sneak peek functions improperly are punished more often in terms of volume of leads offered to them and/or amounts of discounts credited to their accounts. An embodiment that stochastically punishes abusers of the sneak peek functions in terms of volume and/or discount is discussed in more detail in conjunction with FIG. 3C.

If the response to the at least one or both of the questions imposed in step 222 is No (false) then path 222d is taken to step 223. In step 223, the current bidder (i.e., bidder number 0) is awarded the opportunity for a partial or full sneak peek (via signal transmission 139) to the initially won lead. In one embodiment, a short invitation is first sent for agreeing to receive a longer sneak peek transmission and an invitation timer is started for timing how long it takes for the current bidder to respond to the invitation with a yes or no. If the invitation is affirmatively declined or the invitation timer runs out of its system defined amount of time, that situation is treated as a rejection of the lead. In another embodiment, the initial invitation sequence is bypassed and the actual sneak peek transmission is instead sent immediately. A response timer is started for timing how long it takes for the current one bidder to respond with either an acceptance or a rejection of the initially won lead after having been given the opportunity to review the sneak peek transmission data. If the response timer exceeds a predetermined time-out limit (i.e., 10 seconds), then control is automatically passed to step 224 even if the bidder (or as is more often the case, the bidder's machine 155) has not yet responded. Otherwise, the system waits for step 254 to be carried out in the current bidder's machine (155).

In one embodiment, only a partial glimpse of lead details is given (i.e., a predefined subset of the lead details and/or to a predefined level of resolution are presented such as price, location down to the town or city level of geographic resolution, but not the exact identity of the prospective consumer). In another embodiment (referred to herein also as the full-trust embodiment), the full lead is presented or delivered to the current bidder with the understanding that if that bidder does not accept obligation almost immediately (i.e., within 10 seconds) to pay for it, it will be offered to a next lower bidder on the waiting list within very short time (i.e., within the next 30 seconds) and the accepting lower bidder will be handed the exclusive right to immediately engage with that consumer regarding that lead if that next bidder accepts or if that next bidder is not subscribed to the sneak peek function. Within step 254 and during the short time (i.e., 10 seconds) given for the sneak peek, the bidder's machine 155 should receive the sneak peek signal, automatically review the sneak peek data embedded in that signal and it should automatically ascribe one or more, first peek value scores to that sneak peek data. It is left to the discretion of the bidder to formulate specific algorithms for scoring or otherwise valuing the respective sneak peek transmissions presented to them where the scoring/evaluation is in accordance with the peculiar needs of that specific bidder or vendor. (Full viewings of lead details under trust mode may also be used in blast mode where all competing ones or a whittled down plurality of competing bidders simultaneously receive a sneak peek opportunity as shall be detailed in FIG. 2B.)

By way of a non-limiting example, the bidder's local scoring algorithm (254) may ascribe higher scores to certain local towns or cities over other geographic areas. By way of a further example, the bidder's local scoring algorithm may ascribe higher scores to certain price ranges of properties than to others and higher scores for certain credit ratings given to the corresponding consumers over other types of credit ratings. More specifically some bidders may prefer consumers with poorer credit ratings while others may prefer those with higher credit ratings. It is often a case of individual needs by the specific bidder or vendor rather than a generalized agreement as to what lead is more valuable than another and by how much. The first peek score given to a specific peeked-at lead may differ from one bidder to another even though the sneak preview data is the same. The automatically generated first-peek scoring data in the bidder's machine (155) may be used to determine whether to automatically accept the initially won lead or to automatically toss it back into the heap for another bidder to look at. In some cases there may be a gray zone where the automated software (254 which is running in machine 155) cannot definitively make up its mind whether to clearly accept or clearly reject the given lead. In that case the bidder's machine may score the first peek as having a gray zone value and may prompt the human operator to take a second look (a second peek) at the detailed data and to manually determine whether to accept or reject the lead whose first sneak peek received a gray zone evaluation from the automated evaluation means (254). Depending on the number of gray zone peeks the human operator is dealing with and/or how much time the operator has, the operator may take that second look and assign a second peek score to the lead or the operator may ignore it, in which latter case, the bidder's machine may elect to send out a rejection before the timer of step 223 runs out.

In one embodiment, the automatic analysis process 254 in the bidder's machine generates an evaluation score representing a comparative value assigned to the peeked-at data indicative of where on a normalized valuation scale (i.e., where on a scale of 1 to 10, or 1 to 100) the bid upon informational item (the lead) probably falls relative to predefined other informational items (i.e., predefined normative leads) of representative high and low valuations (i.e., where one of the normative leads scores as a 1, another as a 5 (gray zone) and another as a 10 on a normative scoring scale of 1 to 10.) In one embodiment, this normative value and its range (i.e., 8 out of 10) is sent back to the central match and bid system 130 for recordation and subsequent attribution to the sponsor 122. Sponsors (promoters) 122 who consistently score well with these normative evaluations across the spectrum of bidders may be deemed as higher quality sponsors while lead promoters who consistently score poorly with these normative evaluations may be deemed as lower quality sponsors and deeper discounts may be automatically meted out by supervisory system 130 for leads provided through activities of such lower quality sponsors.

In a typical bidding environment, each bidder's machine may receive many leads over a short period of time (i.e. each hour) and a significantly large number of such sneak previews may produce gray zone evaluations on first peek that call for human intervention. However, as mentioned above, the human operator staff may only be able to process so many gray zone evaluations at a time. Accordingly, the bidder's machine (155) should include software for prioritizing the first round sneak peeks that have received automated gray zone evaluations so as to thereby determine which gray zone sneak peek should be retained for being first presented to a human operator and which next and which gray zone sneak peek to return to the match and bid system 130 as being a reject based on the prioritization scores ascribed to those sneak peeks and the fact that the human operator will not have time to look at them.

After automatic and/or manual scoring of a given lead is completed, and a decision is made to accept the offered lead, the bidder's machine (155) may further decide to automatically associate one or more continuation instructions or actions to the given lead (the one that has been or will be accepted) based on the score or scoring parameters assigned to the sneak peek preview of the lead. In one embodiment, the one or more score-based instructions include identifications of one or more continuation websites (e.g., URL's) to which the corresponding consumer will be next directed in order to continue negotiating with the vendor's agent (bidder) or directly with the vendor. For example, if a given consumer is scored as having a relatively low credit rating, then the next instruction to the consumer will be to navigate to a particular website (as identified by its URL or universal resource locator) that is dedicated for further interrogating such consumers having low credit ratings so as to better service their specific needs. If, on the other hand, the corresponding consumer has a high credit rating, then a different URL and/or other continuation instruction is generated for further processing the lead (i.e., #L-Y) and/or contact with the corresponding consumer (i.e., 116). The one or more score-based continuation instructions (i.e., URL's 255) or automated actions are logically associated with the lead identification. In FIG. 2A this logical association is represented by dashed line 256 and the correspondingly won and accepted lead (i.e., #L-W), whether delivered now or at a later time, is denoted as 259. In the illustrated example, one or more specific continuation URLs 255 are logically attached to the won lead 259 by way of logical link 256. Then, when the full lead 259 (i.e. #L-W) is later delivered into the bidder's machine 155 if not already there, the earlier-established logical association 256 is automatically re-established (if such re-establishment is needed) and the corresponding one or more continuation instructions (i.e., URL(s) 255) are returned to the consumer's machine (113 in FIG. 1) for execution thereof, thereby automatically causing the consumer's machine (113 in FIG. 1) to automatically navigate to the desired continuation site and to automatically present the same to the consumer (e.g., 116). This can all be done very quickly (i.e., in less than a second) and the consumer may perceive nothing more than an almost immediate response to his inquiry by a matching product/service vendor (namely the bidder who won in step 214 and accepted the lead in step 254).

When execution in the bidder's machine of external process 254 completes (or the preset time of step 223 runs out in FIG. 2A), control passes to step 224 which executes in the match and bid system server 130. Step 224 determines whether control was returned due to a time-out or due to rejection by the corresponding bidder or for some other reason (i.e., transmission error). If there was neither a rejection nor a time-out nor a hardware malfunction, then the decision is taken to be that of acceptance (No reject or time-out) and control passes to step 227. (Transmission errors and/or hardware malfunctions may be handled by various exception handling processes.) In step 227 the accepted lead is logged for full delivery to the bidder or his designated delegate if the lead has not already yet been fully delivered to the accepting bidder by way of a full preview mode in step 223. The accepted lead is removed from the heap of leads in the corresponding auction bin so that no other bidders can bid on that same lead and further bidding for that lead is thereby halted. Additionally, the time taken by mechanism 254 to accept the lead is recorded in a history record associated with the given bidder. The process then exits via step 230.

If the match and bid system 130 determines in step 224 that control was passed to step 224 due to a rejection or a time-out (Yes) then control next passes to step 225 where a corresponding rejections count or a corresponding time-outs count of the corresponding bidder is updated. In one embodiment, the update keeps track of the number of rejections or time-outs in the last N sneak previews transmitted to the bidder's machine (155) where N is an operator-picked integer greater than 1. If step 224 passes control to step 225 due to a rejection, step 225 further records the time taken by the given bidder (or his machine) to return the rejection signal to the match and bid system 130.

Next, in step 226, after a rejection or time-out has occurred the given bidder is removed from the list of potential bidders to be offered a sneak preview of the given lead and the pointer is advanced to the next bidder (or next bidder group if blast mode is active) in the pre-shuffled list that was formed in one or more of steps 214-218. Control is then returned to step 221 for repeat of the test performed therein. In this way, successive bidders (or bidder groups) who have subscribed to the sneak peek function are given the opportunity to get a one-at-a-time sneak peek (or a blast mode peek—as shall be seen) at one or more details of the bid upon informational item (i.e., lead #L-W 259) and to determine based on that sneak peek whether to accept obligation to pay for the bid upon informational item or not. At the same time, those of the successive bidders who have not subscribed to the sneak peek function are awarded the lead immediately if one of steps 226 and 220″ points the current bidder pointer to them. Thus the system operates as hybrid one that allows sneak peekers to mix together in a same bidding bin with non-peekers. In one embodiment, the amount of money the accepting bidder is charged can be an amount that is automatically downwardly readjusted (discounted) from that bidder's initial bid if the match and bid system 130 determines that the informational item (i.e., lead) is of low quality based on the identity of its sponsor (122) and/or based on other data obtained during the processing of the lead (i.e., low scores given to the lead by other previewing bidders).

Referring to FIG. 2B (blast mode), it is now assumed that the answer to step 220 of FIG. 2A was Yes, thereby indicating that blast mode is active. In this case one or more of steps 214, 215 and 218 will have generated an ordered list of bidders (based on assigned scores and fairness factors) that may include a contiguous plurality of bidders who constitute a highest ordered multi-bidder group where all members of that top, multi-bidder group are ones who have subscribed to blast mode services and have indicated online their agreement to play according to system defined rules regarding blast mode. The rules may vary from system to system (and/or from one product/service line to the next) and are left to the system operator to define. Generally, if the top M scorers coming out of one steps 214, 215 and 218 are pre-subscribed to blast mode type sneak peek services (where M is greater than 1 and typically a variable but can be capped by the system operator to a predefined maximum integer value such as, say 20 if so desired—thereby limiting blast transmissions to 20 bidders at a time) and blast mode is active, then the system 200′ will automatically combine those M top bidders (in step 220′″—triple prime) into a single blast mode group to whom it is intended to simultaneously transmit (i.e., multicast) a sneak peek offer and/or an actual sneak peek transmission (i.e., limited peek or full trust) and to thereafter wait for no more than a limited time to see if and how many members of the blast mode group respond with acceptances (at their initial bid amounts or optionally at raised or decreased bid amounts). However, if it occurs that when blast mode is active, there is a single non-subscriber to sneak peek who scores above the multi-bidder blast group in the ordered list generated by one or more of steps 214, 215 and 218, then that one non-subscriber will be deemed as the highest ordered group and he or she will be automatically awarded the lead when control next passes from step 220′″ of FIG. 2B via path 220a′ and through 221′ to 227 of FIG. 2A. Thus, even when blast mode is active, non-subscribing bidders may continue to participate as non-peekers and they may continue to generally win leads when they, the non-subscribing bidders, are the highest bidders. The illustrated system 200-200′ allows for integrated servicing to non-subscribing bidders, and to bidders who only subscribe to sequential sneak peek and to bidders who subscribe to sequential and blast mode services and the concomitant participation rules of the respective sneak peek class of services.

Assuming the answer at step 221′ of FIG. 2B is Yes and the current highest group on the list consists of bidders who all subscribed to blast mode services, then path 221b′ is followed optionally to strip-out step 222A′ or alternatively via bypass route 221c′ is taken to timer-starting step 223′. Assuming the system 200′ is programmably configured to execute the strip-out step 222A′, in this step the multi-bidder group is cleansed (on an always basis or on a stochastic basis) of those bidders who are flagrant violators of the blast mode participation rules. The rules may vary from system to system (and/or from one product/service line to the next) and it is left up to the system operator to define whether strip-out step 222A′ occurs at all and if so what thresholds are used for always removing violators and/or for stochastically punishing such violators for having exceeded predefined time-out quotas (with no response) and/or rejection quotas and/or for persistently being the slowest ones in a blast group to reject or accept (thus persistently causing the timer started in step 223′ to run close to its set time-out limit). Alternatively or additionally, bad behaviors can be disciplined in the second round contest that takes place at 214″ by reducing their frequency of wins and or reducing possible discounts as discussed below (see FIG. 3B). Warning messages are automatically sent to violators when the disciplinary actions are taken so as thereby give the violators an opportunity to mend their ways and to enjoy the benefits of increased win volumes and/or or deeper price discounts.

In step 222B′ of FIG. 2B it is determined whether any members are left in the post strip-out group. If no members are left, control passes to a modified version (226*) of step 226 of FIG. 2A. The modification is that step 226 will thereafter transfer control to step 221′ of FIG. 2B if blast mode is active.

If step 222B′ determines that there are one or more members still left in the post strip-out group, control passes via path 222d to step 223′. Alternatively, step 223′ may be entered by way of bypass route 221c′.

In step 223′ a count is taken of how many members there are (i.e. Mₘₐₓ) in the blast group and a response timer is started for the group. Part of the blast mode participation rules may be that each subscriber will endeavor to respond with an indication of acceptance or a rejection in a time frame less than that of the response timer. If everyone complies, then the time needed to transition into step 224′ can be held to less than the blast-mode time-out duration and system response time can thus be desirably shortened (i.e., in responding to on-hold hot-contact consumers). After the timer is started and/or the count is taken, sneak peeks are transmitted in substantially simultaneous fashion to the machines (155) of the bidders in the group. This multicast transmission is represented by multiple lines 249′ heading towards the multiple machines (only one schematically shown in area 250″) of the respective bidders.

Region 250′ of FIG. 2B is similar to that 250 of FIG. 2A except that the former 250′ represents parallel processing by the plural machines of the blast mode group. In respective steps 254′ of those parallel executing machines and during the short time (i.e., 20 seconds) given for the parallel sneak peeks, the bidder's machines 155 should receive the respective multicast sneak peek signals, automatically review the sneak peek data embedded in those signals and automatically ascribe one or more, first peek value scores to the received sneak peek data. It is left to the discretion of each bidder to formulate specific algorithms for scoring or otherwise valuing the respective sneak peek transmissions presented to them where the scoring/evaluation is in accordance with the peculiar needs of that specific bidder or vendor. Of course, the operator of the system can provide custom tailorable software to subscribers for allowing to more easily subscribe to various sneak peek services (blast mode or sequential mode or both). Full viewings of lead details under trust mode or partial sneak peeks may be used in blast mode just as they may be in sequential mode.

One difference in the case of blast mode (FIG. 2B) is that there can be a second round of bidding or auctioning 214″ after the blast mode responses are collected in step 224′. Accordingly, an “acceptance” signal output by a bidder's machine does not generally bind the bidder immediately to being obligated to pay for the accepted because the blast mode bidder will typically have to enter at least one more bidding contest (214″) if a multi-award mode is not active. Blast mode responders may elect to automatically retain their original bid amount (as specified in their bid profiles) after having analyzed the sneak peek and to submit an acceptance as such. Alternatively, blast mode responders may elect to automatically increase or decrease their original bid amounts after having analyzed the sneak peek data, where the amount of change may be an automatic function of the score the bidder's machine ascribes to the lead after the sneak peek. Finally, each respective bidder machine may decide to indicate its rejection of the lead after having analyzed the sneak peek data and to provide a normalized score for thereby helping the system operator to monitor lead quality and to thereby attempt to improve the quality and/or types of leads supplied to the system by promoters. Each bidder machine may optionally associate a post-win, next instruction or navigation direction 255′ for use with the lead in anticipation of the case where the bidder actually wins in the next bidding round 214″. However, in blast mode, the sought lead 259′ is not yet won unless there is only one accepting bidder left in the blast mode group after responses are collected.

As bidder's machines (250′) begin to respond affirmatively or in the negative to the peeked-at lead, a count of the number of responses is accumulated in module 224′. If the entire group responds before the timer of step 223′ runs out (or the global soft timer runs out), then module 224′ immediately proceeds to step 225′ thus reducing the wait time of an on-hold consumer or other user. If the full count to whom the sneak peek was blast-wise transmitted is one, module 224′ can immediately pass control to step 215″ since there is no point in having a second contest 214″ or a multi-award operation 262. As the response signals come into module 224′ from the various plural bidder machines, module 224′ logs their respective response times and current counts of rejections, acceptances in as-is form and acceptances with up ante or down antes of the original bid amounts as well as normalized scores returned for the lead in question (259′). This accumulated data can be used to define punishments or rewards for the respective bidders and/or to determine market-perceived quality of the offered lead (i.e., if all blast mode bidders like it and bid up in their acceptances, that may indicate it is indeed of very high quality lead). In an alternate embodiment, rather than waiting for a full count or a time out, step 224′ may be configured to immediately pass control to step 225′ after a predetermined number of acceptances has been received and/or after the number of received acceptances matches or exceeds a predefined contest-initiating value (or a predefined multi-award threshold value) where said value can be, for example, a predefined percentage (i.e., about 67%) of the blast mode group. Blast mode group members who fail to respond quickly enough to get into the predefined subset of acceptors are not penalized as long as they nonetheless respond in accordance with the agreed upon response policies of the sneak peek service.

In step 225′ a determination is made as to whether there are any acceptors. If no acceptors are present, control passes to a modified version (226*) of step 226 of FIG. 2A. The modification is that step 226 will thereafter transfer control to step 221′ of FIG. 2B if blast mode is active. If the global soft timer of step 212 runs out, the lead will be managed as described with respect to the global soft timer.

If step 225′ determines that there are two or more competing acceptors still remaining, control passes to step 261 and possibly thereafter to step 214″ where the second contest is conducted. If step 225′ determines that there is just one acceptor, it instead passes control directly to step 227 of FIG. 2A.

In step 261 it is determined whether multi-award mode is active or not. If No, control passes to 214″. Often the answer will be No if the informational item in question is a hot contact lead. It will be awkward to have two or more bidders simultaneously getting on the phone line to have a competitive conference call with a hot contact consumer. However, such a possibility is not outside the contemplation of the present disclosure. Situations may arise where the hot-contact consumer expects such a competitive conference call and welcomes it. In that case, the value K used in step 262 will generally be set to a low number greater than one such as 2 or 3 but not much more. On the other hand, if the informational item in question is a call-back type such as a non-hot contact lead, where the winning bidder(s) is/are expected to follow through by calling or calling back the target consumer, then multi-award mode may be active at the discretion of the system operator or based on a consensus decision voted on by participating bidders, where the vote is automatically taken by the supervisory system. When multi-award mode is active (a Yes in response to test 261), control passes to step 262 where the informational item is simultaneously awarded to no more than a highest listing K acceptors who first responded back with acceptances (on a first responding, first listed basis) and the K acceptors (or less than K acceptors if step 224′ produces less) are expected to contact the (i.e., call back) the corresponding consumer on their own and gain contact with that consumer on a first come, first gets basis. The setting of the value K to an integer greater than one may be established at the discretion of the system operator or it may be based on a consensus decision voted on by participating bidders, where the vote is automatically taken by the supervisory system. In one class of embodiments, including for example those serving consumers who seek mortgages or refinancing on their houses, the value of K is set in the range 3-5. For example, if K=4, the top scoring 4 mortgage companies would contact the consumer and vie for his business. After the multi-awarding step 262 is carried out, control passes to a modified version (227*) of step 227 of FIG. 2A. The modification is that step 227* will thereafter log the accepted lead for simultaneous delivery to the K or less accepting bidders and debit each of their accounts an appropriate amount for having obligated themselves to such simultaneous delivery of a multi-award mode informational item.

If multi-award mode is active with full trust views, it is possible for unscrupulous participants to try and cheat by rejecting all or most of the leads after having seen a full trust peek and by contacting the corresponding consumer anyway. In one embodiment, means are included in the system for catching such cheaters. A log is kept of bidders who exhibit unusually high reject rates while having access to full trust peek or other sneak peeks that give away the consumer's contact information. Every so often, these high rejecters, but not the low frequency rejecters, are fed system generated, phony leads that are tailored to statistically match leads that these high rejecters have predominantly rejected in the past even though many alike but honest bidders accepted them. Such an acceptance versus rejection differential would indicate the high rejecters are acting in an unusual manner. Then when the unscrupulous participants try to contact the phony leads, the participants find themselves instead contacting a system warning page (e.g., web page or phone message) that warns them they are not playing according to system rules and that such infractions lead to penalties. The system may also penalize these unscrupulous participants by decreasing their discounts and/or reducing their chances of winning rescoring rounds and/or by revoking their sneak peek privileges depending on the degree and frequency of transgressions. The system can thus weed out bidders who fail to play by the rules.

Referring to step 261 of FIG. 2B, if the response is No to the test carried out in step 261, then in subsequent step 214″ a stochastic or deterministic process is run to pick the winner of the nonmulti-award blast mode run. Variables that feed into the stochastic or deterministic process may be the same similar to the ones described for step 214 of FIG. 2A, namely, bid amount and history of good or bad behavior with respect to sneak peek services. At step 215″ the winner is picked and control passes to step 227 of FIG. 2A. In an alternate embodiment, step 214″ could pass control to step 262 if a post-second contest multi-award mode is active and step 262 could award the lead to no more than the top K scorers of contest 214″.

Referring to FIG. 3A, a flowchart is shown for a supervisory process 300 executable within the match and bid system 130 for managing the sneak peek process. Although one central flowchart is shown, it should be understood that in one embodiment there are separate entry points 301 and 302 respectively for hot lead contacts and cooler lead contacts. If sneak peeks are being managed for hot leads, then the various parameters used in calculating penalties and warnings are set accordingly (typically to be more stringent) as indicated by logical connection 304. On the other hand if the sneak peeks that are being managed by a flow through steps 312-340 are for cool leads then per logical association 303 and box 311 the penalty amounts used may be based on different formulas (typically more lenient) than those used for the hot leads and the warning thresholds may also be different. The reason that penalty amounts and warning thresholds are typically more stringent for the hot leads as compared to the cooler leads is that the hot leads have a much shorter time span for tolerating slow rejecters or for tolerating bidders who fail to reject or accept at all and instead consume their full time-out. In the case of a hot-lead there is usually a consumer at the other end of a live contact link, anxiously waiting for an operator (winning bidder) to pick up the link and pursue the closing of a deal with that consumer.

After entering the process either by way of entry point 301 or 302, in step 312 the system (300) tests each subscribing bidder's last N trailing time-outs count (the number of times that a time-out occurred in the last N times that a sneak preview was granted).

In step 313 it is determined whether the given bidder is over his or her maximum quota for time-outs and if yes, it is determined how far over the quota the given bidder has gone. A same quota may be given to all bidders or different quotas may be given to different bidders based on the type of sneak peek service being used (partial or full trust view and/or sequential versus blast mode) and on the types of properties being managed, behavior histories collected by the system regarding the different bidders (i.e., previous violators may be given more stringent second chances after acknowledging their previous bad behavior) and/or based on other design choices made by the system operator (not shown) of the trading system 100. In step 314 a predetermined formula is used to calculate a penalty that will be assessed against the bidder due to his going over the respective quota by the given amount. Any number of factors may be used for calculating the penalty including accessing a percentage of that bidder's current bid amount against the bidder based on the extent to which he is over the quota. Additionally step 314 may formulate an electronic warning message that is to be sent to the bidder's computer 155 to indicate that the penalty has been assessed and to indicate the reason for the penalty and/or to ask the bidder to acknowledge receipt of such notice and to promise to behave better in the future. In this way the bidder's machine 155 (or the human bidder himself) may be given fair notice of the violations and may be given an opportunity to take remediatory actions to prevent or reduce further infractions and further penalties. (One of the remediatory actions that the bidder may elect to take is to drop his/her subscription to sneak peeks for that product/service line.)

Control next continues into step 315 where the last N′ trailing reject counts of the given bidder are tested (where N′ is an integer that can be the same or different from N of step 312). In step 316 it is determined whether the given bidder is over his or her maximum quota for rejects over the last N′ sneak previews given and if so by how much. If Yes, control passes to step 317 where an appropriate penalty is calculated and/or an appropriate electronic warning message is formulated and sent to the bidder's machine.

Control next passes to step 322 where a determination is made as to whether the given bidder is overly slow in time-to-acceptance over the last M acceptances based on the recorded acceptance times of that bidder as provided by step 227 of FIG. 2A. Acceptable times for response may vary based on context. For example time allowed for acceptance in blast mode may be longer than that allowed in sequential mode. In step 323 a quantitative value is automatically generated for indicating how excessively slow the given bidder is in his time-to-accept history. If the quantitative value exceeds a predetermined threshold then control passes to step 324 where a corresponding penalty is assessed and/or a warning message is formulated and sent to the bidder's machine.

Control next passes to step 325 where a test is performed of the bidder's slowness in rejecting over the last M′ rejections returned by that bidder's machine. Once again, acceptable times for response may vary based on context. For example time allowed for rejection in blast mode may be longer than that allowed in sequential mode. In step 326 a severity factor is calculated to determine whether the bidder exceeds a predefined threshold and if yes by how much. In step 327 a corresponding penalty factor is calculated if the bidder is over the allowed threshold and an electronic warning message is transmitted to the bidder's machine.

Control next passes to step 332 where one or more tests are performed regarding the bidder's good behavior(s) in regard to use of the sneak peek functions (e.g., frequent acceptances and relatively short acceptance time which could be termed as indicating quickness of acceptances and frequency of acceptances). In step 334 a corresponding one or more bonus factors are calculated for use in awarding the bidder with certain perks for good behavior, such as increased volume of offered leads and/or steeper discounts on charges levied against that bidder's account. Control next passes to step 336 where after having finished processing a first bidder the system (300) may automatically repeat from step 301 or 302 for a next bidder as machine bandwidth currently permits and so on. The process may periodically exit to step 340 to provide bandwidth to other processes executing within the automated match and auction system 130.

With each calculation of a penalty factor or bonus factor, the corresponding data is sent to a collection and recording module 350. Thus reward/penalty factor signals 314a, 317a, 324a, 327a and 334a are transmitted from respective modules (i.e., processing steps) 314, 317, 324, 327 and 334 to collection module 350. The accumulated data (and/or rolling averages thereof over time) are used for adjusting the weighting of the stochastic dice used in the probabilistic auction processes, if used, or the deterministic functions, if used, in respective steps 214 (FIG. 2A) and 214″ (FIG. 2B) so as to thereby reward well behaving bidders with relatively increased volumes of offered leads and to punish badly behaving bidders with relatively decreased volumes of offered leads. Module 350 may alternatively or additionally adjust the amount of discount awarded to each bidder according to good and/or bad behaviors of that bidder in regard to use of the sneak peek functions.

Referring to FIG. 3B, shown is simplified graph 360 for explaining how module 350 may adjust the weighting of the stochastic dice used in the probabilistic auction process (if used there) of step 214 (FIG. 2A) so as to thereby reward well behaving bidders and to punish badly behaving bidders. The y axis represents a highest bidder's chances (call him bidder A and assume he also has the highest initial score prior to stochastic rescoring process 374 of FIG. 3C) of keeping his initially highest score after stochastic rescoring. The maximum probability is of course 100% (369) while the lowest is 0%. However, the match and bid system 130 may be configured to establish other maximum probability and minimum probability bounds, 366 and 361 respectively, for all bidders. Alternatively or additionally, yet other maximum probability and minimum probability bounds, 364 and 362 respectively, may be set by the system for the given bidder A.

The x axis represents a sum of weighted factors that may be applied against the bidder (or in his favor) for decreasing (or increasing) his chances away from (or towards) achieving the higher saturation levels i.e., 369, 366 or 364. For a relatively middle range of weighted factors sums 363a, the bidder's chances may be represented by sloped region 363 of the S-shaped saturation curve. However, if the bidder has too many negative factors (as summed and projected onto the x axis by unit 367) then his probability will saturate down into the flat of his minimum level 362. And similarly, if the given bidder A has an overabundance of positive factors then his probability will saturate up into the flat of his maximum allowed level 364. The piece-wise linear saturation plot 362-363-364 shown in FIG. 3B is understood to be an example. Nonlinear probability curves may be used instead.

Among the negative factors that can be weighted (per system operator elected negative weights w₁-wₙ) and summed (367) to form the x input value, there can be included one or more of the following: a first value indicating how slow of a rejecter bidder A is when it came to responding with his last N rejections, a second value indicating how slow of an acceptor bidder A is when it came to responding with his last M acceptances, a third value indicating how frequent of a rejecter bidder A is when it came to responding to the last P sneak peeks offered to him, a fourth value indicating how frequent of a time-outer bidder A is when it came to responding to the last P sneak peeks offered to him, and a fifth value indicating that there are one or more other bidders who have bid above bidder A's bid value (this fifth one does apply when bidder A is the highest bidder). There may of course be other probability detracting factors 365 that are weighed and summed by unit 367.

Similarly, among the positive factors that can be weighted (per system operator elected positive weights +wₚ-+w_{q}) and summed (367) to form the x input value, there can be included one or more of the following: a first value indicating how fast of a rejecter bidder A is when it came to responding with his last N rejections, a second value indicating how fast of an acceptor bidder A is when it came to responding with his last M acceptances, a third value indicating how frequent of an acceptor bidder A is when it came to responding positively to the last P sneak peeks offered to him, a fourth value indicating how infrequent of a time-outer bidder A is when it came to responding to the last P sneak peeks offered to him, and a fifth value indicating that there are one or more other bidders who have bid below bidder A's bid value and to what extent (this fifth one does apply when bidder A is the lowest bidder). There may of course be other probability enhancing factors 368 that are weighed and summed by unit 367.

In one embodiment, each bidder who behaves badly with respect to use of the sneak peek functions (e.g., frequent rejecter, slow responder) risks having his randomizing function shifted to a lower mean and a wider peak in accordance with what is shown for example at 355. The reduced (down-weighted mean) implies that the bidder will more often have lower scores after stochastic rescoring is conducted. The broader distribution of the bell shaped curve implies that the bidder will more often have scores that deviate from his mean. Either or both of these adjustments to the bidder's randomizing function will generally result in a reduced number of wins being awarded to him by the automated auctioning/bidding bin (step 214) and thus a reduced volume of leads flowing to him because his competitors will begin to win over him more often (unless that is, the badly behaving bidder raises his bid amount significantly; but then he is being punished monetarily for his bad behavior).

In one embodiment, the following one or more methods may be used for readjusting the relative randomizing functions as between every pair of competing bidders (e.g., bidders A and B). Let bid_{A} be the bid amount of bidder A and score_{A} be an initial score awarded to bidder A based on how bidder A bids for the lead (or other informational item) relative to how another, bidder B bids and also optionally based on additional scoring criteria (e.g., rewards and punishments for respective good and bad behavior with regard to sneak peeks and/or other services provided by the match and bid system 130). After the stochastic readjustment, bidder A will have an adjusted new score_{AA} that is a stochastic function of his initial score and possibly of other factors while bidder B will have an adjusted new score_{BB} that is similarly a stochastic function of B's initial score, score_{B} and possibly of other factors.

Assume bidder A submitted the higher initial bid, bid₀. In one embodiment, it is desirable to weigh the probability, P(AA>BB), that the new score (score_{AA}, also denoted as score₀ prime below, or score₀′) for the higher bid, bid₀, will be greater than the new, stochastic readjusted score for bidᵢ so that this probability, P(AA>BB) is a function of the ratio of the initial scores. Also, P(AA>BB) It should be 0.50 when the difference between initial scores is 0 and it should be P(AA>BB)=1.00 when the ratio between scoreᵢ and score₀ is equal to some operator-predefined minimum percentage value, m % per the following equations, Eq. 1 and Eq. 2:

$$\begin{matrix}m \% \leq r = \frac{{score}_{i}}{{score}_{0}} \leq 1 & \{ Eq . 1 \} \\ P ( {score}_{0}^{′} ( {bid}_{0} , {score}_{0} ) \geq {score}_{i}^{′} ( {bid}_{i} , {score}_{i} ) ) = 1 - \frac{\frac{{score}_{i}}{{score}_{0}} - m \%}{2 ( 1 - m \% )} & \{ Eq . 2 \}\end{matrix}$$

A skewed randomizing function (a loaded die of chance) is to be structured to provide this stochastic outcome. Note that the die loading operation of equation Eq. 2 is essentially a first order approach that gives a straight line change in probability as r varies from m % to 1 and that P(AA>BB) saturates at 1.0 once the value of r decreases to m % or below. In another embodiment, however, it is desirable to provide a probability curve that changes nonlinearly in the range r=m % to 1, so that the probability P(AA>BB) remains relatively high until scoreᵢ (the initial score of the competing bidder, B) gets substantially close to score₀ (the initial score of the highest bidder, A). This is accomplished in a second embodiment by raising the portion of Eq. 2 that ranges from 0 to 1 to some predefined power, k greater than unity per the following equation, Eq. 3:

$$P ( {score}_{0}^{′} ( {bid}_{0} , {score}_{0} ) \geq {score}_{i}^{′} ( {bid}_{i} , {score}_{i} ) ) = 1 - .5 {( \frac{\frac{{score}_{i}}{{score}_{0}} - m \%}{( 1 - m \% )} )}^{k} \qquad \{ Eq . 3 \}$$

In one embodiment, the following additional readjustment criteria (Eq. 4) is imposed for stochastically determining the new score by use of a skewable randomizing function, rand(mean) having for example a Gaussian or other bell shaped probability distribution and a weightable mean per the following equation, Eq. 4:

scoreᵢ′=rand(ωᵢ*scoreᵢ) where 0≦ωᵢ≦1 and ω₀=1 {Eq. 4}

Replacing the above into the probability function of Eq. 3, the following equation, Eq. 5 is obtained:

$$P ( rand ( {score}_{0} ) \geq rand ( {ω}_{i} * {score}_{i} ) ) = 1 - .5 {( \frac{\frac{{score}_{i}}{{score}_{0}} - m \%}{( 1 - m \% )} )}^{k} \qquad \{ Eq . 5 \}$$

Since 0≦ω≦1 and scoreᵢ≦score₀, it can be shown that ωᵢ*scoreᵢ≦score₀.

Using this fact, the probability equation (Eq. 5) can be split into a union of two probabilities per the following expression, Eq. 6:

$$\begin{matrix}\begin{matrix}\begin{matrix}P ( rand ( {score}_{0} ) \geq \\ rand ( {ω}_{i} * {score}_{i} ) )\end{matrix} = P ( rand ( {score}_{0} ) \geq rand ( {ω}_{i} * {score}_{i} ) \vert rand \\ ( {score}_{0} ) > {ω}_{i} * {score}_{i} ) * P ( rand ( {score}_{0} ) > {ω}_{i} * \\ {score}_{i} ) + P ( rand ( {score}_{0} ) \geq rand ( {ω}_{i} * {score}_{i} ) \vert \\ rand ( {score}_{0} ) \leq {ω}_{i} * {score}_{i} ) * P ( rand ( {score}_{0} ) \leq \\ {ω}_{i} * {score}_{i} ) \\ = 1 * P ( rand ( {score}_{0} ) > {ω}_{i} * {score}_{i} ) + 0.5 * P \\ ( rand ( {score}_{0} ) \leq {ω}_{i} * {score}_{i} ) \\ = \frac{{score}_{0} - {ω}_{i} * {score}_{i}}{{score}_{0}} + {0.5}^{*} \frac{{ω}_{i} * {score}_{i}}{{score}_{0}} \\ = 1 - 0.5 \frac{{ω}_{i} * {score}_{i}}{{score}_{0}}\end{matrix} & \{ Eq . 6 \}\end{matrix}$$

Combining this with the other value for the probability gives the following expression, Eq. 7:

$$1 - 0.5 \frac{{ω}_{i} * {score}_{i}}{{score}_{0}} = 1 - .5 {( \frac{\frac{{score}_{i}}{{score}_{0}} - m \%}{( 1 - m \% )} )}^{k} \\ \frac{{ω}_{i} * {score}_{i}}{{score}_{0}} = {( \frac{\frac{{score}_{i}}{{score}_{0}} - m \%}{( 1 - m \% )} )}^{k} \\ {ω}_{i} = \frac{{score}_{0}}{{score}_{i}} * {( \frac{\frac{{score}_{i}}{{score}_{0}} - m \%}{( 1 - m \% )} )}^{k} \qquad \{ Eq . 7 \}$$

Using the rescoring process of scoreᵢ′=rand(ωᵢ*scoreᵢ) for i=0 to N-1 where N is the number of bidders) creates a situation where the probability P(AA>BB) that the highest bid's new score is higher than bid i's new score that ranges from 0.5 to 1. A set of logistics-like 3D curves (surfaces) can be generated on an x versus y versus z grid to demonstrate this by graphing the case where

$$m \% = 0.9 , x = \frac{{score}_{i}}{{score}_{0}} \text{:} 0.9 \leq x \leq 1$$

y=k: 0≦y≦2 and z=the probability (P) that the highest bid beats bid i, where the displayed z values range from 0.5 to 1:

In one embodiment that incorporates volume readjustment per the concepts disclosed above for punishing bidders who are slow rejecters of sneak peeks for example, a new variable, mp (which stands for minimum probability) is incorporated into the initial form of Eq. 5 in place of the 0.50 constant per the following expression, Eq. 8 so that P ranges from the new min probability level (mp) to 1:

$$P ( {score}_{0}^{′} ( {bid}_{0} , {score}_{0} ) \geq {score}_{i}^{′} ( {bid}_{i} , {score}_{i} ) ) = 1 - ( 1 - mp ) {( \frac{\frac{{score}_{i}}{{score}_{0}} - m \%}{( 1 - m \% )} )}^{k} \qquad \{ Eq . 8 \}$$

Note that if mp<0.5, then 0≦ω≦1 and scoreᵢ≦score₀ no longer hold, meaning that that ωᵢ*scoreᵢ≦score₀ is no longer true and the derivation of probability in terms of ωᵢ no longer holds. Thus the constraint of mp≧0.5 should be maintained for purposes of remaining within the assumptions of this algorithm.

This gives rise to the following expressions, Eq. 9:

$$1 - 0.5 \frac{{ω}_{i} * {score}_{i}}{{score}_{0}} = 1 - ( 1 - mp ) {( \frac{\frac{{score}_{i}}{{score}_{0}} - m \%}{( 1 - m \% )} )}^{k} \\ \frac{{ω}_{i} * {score}_{i}}{{score}_{0}} = 2 * ( 1 - mp ) * {( \frac{\frac{{score}_{i}}{{score}_{0}} - m \%}{( 1 - m \% )} )}^{k} \\ {ω}_{i} = 2 * ( 1 - mp ) * \frac{{score}_{0}}{{score}_{i}} * {( \frac{\frac{{score}_{i}}{{score}_{0}} - m \%}{( 1 - m \% )} )}^{k} \qquad \{ Eq . 9 \}$$

Plugging the results into scoreᵢ′=rand(ωᵢ*scoreᵢ), the following implementation is obtained as described by following expressions, Eq. 10:

$${score}_{i}^{′} = rand ( 2 * ( 1 - mp ) * {score}_{0} * {( \frac{\frac{{score}_{i}}{{score}_{0}} - m \%}{( 1 - m \% )} )}^{k} ) \\ {score}_{0}^{′} = rand ( {score}_{0} ) \qquad \{ Eq . 10 \}$$

wherein mp is a minimum probability variable in the range 0.5 to 1.0 that is varied as a function of punishments or rewards attributed to the highest bidder A, where mp is reduced as a punishment against A for bad behavior when using the sneak peek features for example.

The mp signal is a tunable variable that establishes the minimum probability that the pre-stochastic winner (A) will still beat any single other bid (B) after the stochastic rescoring process (374). In other words, P(bid₀ beats bidᵢ)>=mp where bidᵢ is an arbitrary other one of the bids made in the bid bin. If mp is set to 0.5, the highest pre-stochastic bid will continue on average to beat any other bid after the stochastic rescoring process (374) at least half the time. If mp is instead set to 0.75, the highest bid will beat any other bid at least ¾ of the time. Thus, the volume of winnings that flow to a given bidder 0 can be adjusted by adjusting the mp value used for rescoring that bidder. In other words, mp establishes a baseline probability that the bid that wins the pre-stochastic bidding round will still beat any single other bid after the stochastic rescoring process (374) is conducted.

The stochastic rescoring process (374) is applied to each bid and his parameters individually and thus its (374's) individual application to a given bidder's score does not of itself determine the probability that the highest bid will still win. The implementation of rescoring by way of the expressions of Eq. 10 for example controls the pair-wise probability with respect to just score0 and score1. As between them, the highest bid will have the highest probability of still winning after rescoring in the case where mp is 0.5 for both.

When it comes to an N-way bidding contest followed by stochastic rescoring of each of the N bids, the mp value assigned to a given highest bidder can define a lower bound on the probability of his highest bid's (bid₀) still winning per the following expression, Eq. 11, where mp is raised to the (n-1) power:

P(bid₀ wins)=P(bid₀ beats bid₁)*P(bid₀ beats bid₂)* . . . *P(bid₀ beats bidₙ)>=mp⁽ⁿ⁻¹⁾ {Eq. 11}

Thus mp has a stronger influence on the highest bidder's chance of winning as more bidders enter the contest and reduction of one bidder's mp value versus raising that of another can have significant effects on outcome probabilities.

Referring to FIG. 3C a flowchart is shown for a corresponding method 370 that may be overlappingly integrated into the system of FIG. 2A and executed in the system 100 of FIG. 1. At step 371, the system starts a soft global timer for keeping track of the lead and making sure it does not disappear into an endless series of sneak peek time outs. At step 372, the system identifies the bidders whose lead-matching profiles place them into competition with each other in the current auctioning/bidding bin of the given lead. At step 373, the system automatically generates initial scores for the identified bidders based on their relative bid amounts for the lead (e.g., based on the amount deltas as between the various bids for the lead) and optionally based on other factors (e.g., fairness factors such as not letting one inexperienced bidder bid way over the average market price for such a lead). At step 374, the system automatically rolls the stochastic rescoring dice (virtual dice as embodied for example by the weighted randomizing functions discussed above) for each of the bidders and records the stochastic readjusted scores. (Alternatively or additionally, a deterministic rescoring process may be used in step 374 for re-scoring or further re-scoring the bids at least as a function the respective behaviors of the bidders to the sneak peek services they participate in.) At step 375, the system automatically manages pools of tied bidders (after the stochastic rescoring) to provide for fairness by way of round robin awarding of wins or other means (e.g., a further stochastic reshuffling of who gets listed at the top of a tied pool of same scores).

At step 376 if the current bidder/blast mode group at the top of the ordering list (usually the highest scorer(s) after stochastic rescoring) has a sneak peek subscription, the sneak peek process is executed (in blast mode or sequential style). If plural responders accept under blast mode in step 376, then a second contest is run if multi-award mode is not active. On the other hand, if multi-award mode is active, among those who responded with an acceptance to the sneak peek within an allotted time window, up the maximum K value of first in line acceptors are simultaneously awarded the same lead. If sneak peek has not been subscribed to by the highest scoring bidder, then step 376 is bypassed. Assuming the current top bidder or all members of a blast mode group look at the sneak peek and fail to accept (i.e., due to a time-out or return of rejections), these bidders are removed from the ordered list that was generated by step 374 and the next remaining bidder or blast mode group at the top of the ordering list is offered the sneak peek(s) or given immediate delivery of the lead if the top bidder has no sneak peek subscription. All this while the global soft timer started at step 317 is running. If the global soft timer times out and there is no ongoing sneak peek session that might yield an acceptor, control over the lead (e.g., an on-hold hot-contact consumer) is automatically passed over to a system center that gracefully handles such dropped leads. If it is an on-hold hot-contact consumer, the system center may include a manual or automated call receiving center whose human or robotic operator apologizes to the consumer for the delay, indicates that a specialist operator was not available to pick up the call and asks the consumer if they would like a call back. If yes, the consumer's call back information is gathered and the hot-contact lead is converted into a non-hot call-back lead and resubmitted to the system for later bidding upon. If the original contact was via a consumer's inquiry email or inquiry button push on a web page, the consumer is replied to via a corresponding e-mail or automatic navigation to an apology web page that indicates that no specialist operator is available to pick up the contact at the moment and asks if the consumer would like to receive an email or call back at a later time. If yes, the consumer's contact back information is gathered and a corresponding non-hot contact lead is generated and seeded into the automated match and bid system 130.

Assuming one or more accepting bidders were found in FIG. 3C, at step 377 the won and/or accepted lead is delivered to the one or more qualifying bidders (or to delegates for receipt that are appointed by the qualifying bidders). At step 378, the system automatically computes the amount of discount to be awarded to each of the lead-receiving bidders. The discount amount can be zero. In one embodiment, the discount amount includes a discount for leads received from sponsors 122 that are identified by the system as low quality sponsors of differing degrees; this implying that the currently won lead has a medium or high probability of being a low quality lead. In one embodiment, the discount amount includes a discount for good behavior by the lead-receiving bidder with respect to the sneak peeks functions of the system. In other words, if the lead-receiving bidder subscribes to sneak peeks for this product/service line and the bidder has good history showing a high acceptance frequency and fast response time, the bidder is awarded a deeper discount. He is financially rewarded for his good behavior. In one embodiment, the system automatically sends a message to the bidder's machine (155) informing it of the amount of discount awarded for good behavior with respect to use of the sneak peek functions. The bidder's machine (155) may use this information to determine whether to keep the subscription for the current product/service line or not.

At step 379 the match and bid system 130 debits the winning bidder's account by the discounted purchase price for the lead. At step 380, the process ends.

Referring to FIG. 4, recall that in some cases, bidders have to pay for sneak peek subscriptions or at least they risk being penalized for not quickly responding to sneak peek transmissions per the system policies they agreed to. So it is wise for the bidder's machine (155) to have a subscription management algorithm executing therein for determining which subscriptions to keep, which to drop and also perhaps which bid profiles and/or blast mode algorithms to revise in view of historic results from sneak peek activities. A flowchart is shown for a sneak peek subscription management process 400 that may be executed in the bidder's computer for managing the subscriptions and the bid amounts used for getting a first chance (in step 215 of FIG. 2A) or a successive one for a sneak peak when competing against other bidders who offer a same bid amount for the informational item (i.e., lead) and also want a sneak peek before accepting.

Regarding steps 401 and 402, different formulations may be used if the corresponding product/service line is one that is predominated by hot-contact leads (401) rather than cool leads (402). In step 412, a determination is made for each bidding profile of this bidder whether to begin a free or paid subscription to sneak peek functions for the given product/service line. Registering for a subscription typically carries obligations, such as the obligation to respond quickly to sneak peek offerings (223) on pain of being penalized for not doing so. So even if the sneak peek function is offered as a free service by the match and bid system 130, it may not be totally free. The bidder and/or his machine (155) has to decide whether to subscribe or not in view of the obligations entailed with subscribing and the expected return on investment for undertaking such obligations. In some embodiments there may be different types of subscriptions, for example different sizes or types of peeks with commensurate charges (including one possibly having a zero money charge to try it out) based on the amount of additional bandwidth that the subscription is expected to consume.

If the profile being looked at by step 412 already has a subscription, then step 412 may instead determine how economically viable it is to maintain the sneak peek subscription. For example, step 412 may automatically determine how much time and/or how much money is being spent on a given sneak peek subscription and whether better economic results may be obtained by eliminating or reducing bandwidth consumed by the current sneak peek subscription. Step 412 may automatically carry out a comparative economic evaluation of results from another sneak peek subscription relative to the one under reconsideration. Then, if it is found that the sneak peek subscription under reconsideration is performing at a return on investment ratio that is below a threshold one derived from comparative other subscriptions, step 412 may automatically generate an indication that the sneak peek subscription under reconsideration should be curtailed or dropped. On the other hand, if it is found that the sneak peek subscription under reconsideration is performing at a return on investment ratio that is above a threshold one derived from comparative other subscriptions, step 412 may automatically generate an indication that it is desirable to upgrade to a more expensive sneak peek service by using metrics such as ones described below. Upon completing its evaluations step 412 may skip forward to step 413, where the decisions regarding the merits of an ongoing subscription under evaluation are converted into actions (e.g., drop or downgrade the subscription or upgrade it). In one embodiment the system charges less for partial peeks than for bigger or full peeks and/or the system charges less for blast mode peeks (and even less for multi-award results) because less bandwidth is needed by the system to for example transmit (139) the details of a small partial peek as opposed to a data-laden full peek that is shown on a sequential basis. The determination of what constitutes a full large peek versus what constitutes small partial peek is left to the system operator. Subscription upgrade or downgrade determinations may be made on the basis of charges assessed by the supervisory system against different ones of such subscriptions (e.g., full or partial peek ones).

In step 413 for example, the bidder's machine determines whether the payback results (return on investment ratio, ROI) obtained from a current sneak peeks subscription is resulting in too many rejections being made by the bidder while not providing a sufficient number of lucrative catches (i.e., closing leads) caught in the net to justify on a comparative or other basis the continued subscribing to (i.e., paying for) the sneak peek opportunities provided by that subscription. If Yes, control passes to step 414 where either the amount bid for the opportunity to have an early sneak peek (in step 215 of FIG. 2A) is lowered (thereby reducing the average number of wins) or the current subscription to the sneak peek function is dropped all together for the given bidder's profile. It is left to each bidder to design the specific algorithm by which his machine (155) will automatically make the yes/no determination in step 413 and the lower/drop determination in step 414. Every bidder can have his own private criteria for what is justified or not. Lowering step 414 may include reducing an amount of up ante for blast mode second rounds if those are returning too many non-closing (non-lucrative) leads.

If the answer to test 413 is No, then control passes to step 415 where the bidder's machine indicates that it will continue subscribing for the sneak peek service for the given bidder profile. In next step 416, the bidder's machine determines whether the payback results (return on investment ratio) obtained from paid-for sneak peeks is resulting in too many penalties being levied against the bidder (i.e., for slow rejection, slow acceptance and/or failure to accept/reject before the time-out window closes) while not providing a sufficient number of lucrative catches (deal conversions) caught in the net to justify having paid for the sneak peek opportunities and/or the assessed penalties. If Yes, control passes to step 414 where either the amount bid for the opportunity to have a first sneak peek is lowered or a subscription to the sneak peek is dropped for the given bidder's profile. It is left to each bidder to design the specific algorithm by which his machine (155) will automatically make the yes/no determination in step 416 and the corresponding lower/drop determination in step 414. Every bidder can have his own private criteria for what is justified or not.

If the answer to test 416 is No, then control passes to step 423 where the bidder's machine automatically examines for positive aspects of the current sneak peek subscription. It tests to see if the current sneak peek subscription is paying off handsomely (as opposed to costing too much) in terms of exceeding a user-defined threshold for number of lucrative catches being caught in the sneak peek net and/or catches that are caught and converted into successful transactions (i.e., conversions). What is meant here by a lucrative catch is that the history of leads caught with aid of this sneak peek subscription shows a comparatively relatively high conversion rate (the vendor closes the deal with the prospective consumer) or a comparatively relatively high score for expectation of conversion and/or the history shows a comparatively relatively high conversion payoff amount (on average, where the payoff amount is the amount of revenues which the closed deals, even if few in number, bring in) when compared against similar metrics provided on average by other comparable sneak peek subscriptions.

If the answer to test 423 is Yes, then one or both of two options may be pursued. Path 424 leads to operation 425 wherein the bidder's machine (155) automatically determines how much to raise the bid for earlier sneak peeks (as determined in step 215 of FIG. 2A) so as to thereby increase the chances of winning more sneak peek contents and increasing the volume of lucrative leads flowing to this bidder. Enhancing step 425 may include raising an amount of an up ante for blast mode second bidding rounds if those are returning many closing (lucrative) leads. Path 426a connects to step 430 whereas alternate path 426b connects to step 428. It is up to the local design of algorithm 400 to determine which one of paths 426a and 426b to use, or if both are used, then to determine what testable conditions result in choice 426b as opposed to choice 426a.

Yes path 427 leads to operation 428 wherein the bidder's machine (155) automatically determines how much to widen the current scope of the net cast by the current bid profile and in terms of what parameters (e.g., geography, product/service price range, etc.). Since test 423 shows that the current use of the sneak peek functionality is netting a good return on investment, widening the scope of the profile may net yet a greater number of lucrative catches or a greater amount of average net revenues. If this widening turns out to produce poorer results, then step 414 will shrink the scope of the profile when process 400 is later rerun for the same profile. Path 429 connects to step 430.

Depending on processing bandwidth currently available in the bidder's machine 155, step 430 may elect to repeat from steps 401/402 for yet another profile belonging to the this bidder or to exit via step 440. In one embodiment, the bidder's machine is configured to run automated performance reviews like process 400 at night or during other slow times when lead acquisition is not consuming most of the machine's bandwidth. During prime time, the bidder's machine is configured to run processes that call for quick real time response, including the real time response to sneak peek transmissions as is handled by the next described process.

Referring to FIG. 5, process 500 (also referenced as 254′ to indicate it is one possible implementation within step 254/254′ of FIG. 2A/2B) is initiated in the bidder's machine 155 when a data transmission is received from the match and bid system 130 and it is determined that the transmission includes a sneak peek or an invitation to receive a sneak peek. In one embodiment, the bidder's machine 155 may automatically reject a sneak peek invitation whenever the bidder's machine determines it has insufficient processing bandwidth at the moment to deal with the sneak peek. In this way, the bidder is not penalized for timing out or taking too long to respond.

Entry point 501 is used in the case of sneak peeks for hot-contact leads. A different entry point may be used for cooler contacts. Different entry points with respective different weighting coefficients may be respectively used also for blast mode sneak peeks as opposed to sequential mode sneak peeks. As indicated in box 505, response to hot-contact leads may entail using faster and less meticulous evaluation techniques because the system-imposed penalties for slow response to hot-contact leads are often more sever than for cool contacts. At step 512, the bidder's machine receives the sneak peek data transmission. At step 514 it identifies the corresponding bidding profile that relates to the received sneak peek data transmission. At step 520 it fetches an appropriate scoring algorithm for initially scoring the received sneak peek data. Each bidding profile may have a different peek scoring algorithm associated with it.

Referring to step 522, lookup tables tend to be quicker than meticulous computations. Thus, a first step 522 is to scan through one or more lookup tables to determine if the sneak peek contains automatic exclusion data or automatic inclusion data. Recall that one of the examples given above entails a bidder/vendor who refuses to do business with certain small towns such as Eureka, Calif. Another of the examples entails a bidder/vendor who is very willing to do business if the consumer's location is listed as Beverly Hills, Calif. Accordingly, step 524 searches for automatic exclusion data such as undesirable geographic location or other and connects to step 526 if found. Step 526 scores the sneak peek as being automatically unacceptable, records the reason for the score (for later review by for example process 400) and passes control to step 528. Step 528 sends the rejection message, and optionally a normalized rejection score, to the match and bid system 130 and then exits via step 530. Similarly, step 534 searches for automatic inclusion data such as desirable geographic location (i.e., Beverly Hills) or other and connects to step 536 if found. Step 536 scores the sneak peek as being automatically acceptable, records the reason for the score (for later review by for example process 400) and passes control to step 538. If blast mode is active and multi-award is not, step 536 may additionally elect to increase or decrease the amount bid for the second contest (214″ of FIG. 2B) depending on the locally generated score. Step 538 sends the acceptance message (or acceptability message), and optionally an altered bid amount and/or a normalized acceptance score, to the match and bid system 130 and then exits via step 540.

In step 542, before beginning any meticulous computations or data searches, the bidder's machine starts real time timer going so that it will generally avoid a time-out penalty in trying to respond to the match and bid system 130. Then step 542 begins a machine automated intelligent analysis of the received sneak peek data and starts producing one or more or both of a local score and an exportable normalized score by adding plus factors and minus factors associated with the received sneak peek data. All the while, control is periodically passed to step 544 to see if the real time timer has run out. If it has, control is passed to step 545 where it is decided to use the current incomplete score(s) rather than trying to complete the analysis.

Step 546 is entered into both in the case where step 542 completes its analysis or in the case where step 545 provides an incomplete and partial score. Step 546 determines whether the locally generated score qualifies as a clear rejection. If Yes, control is given to step 526. If No, control is given to step 548. Step 546 determines whether the locally generated score qualifies as a clear rejection. If Yes, control is given to step 536. If No, control is given to step 550.

Step 550 is entered in the case where there was not clear rejection or clear acceptance. In other words, the automatically generated score fell into a predefined gray zone. Another real time timer is started for limiting the amount of time that will be tolerated for human response. The amount of time allotted may be a function of how close to the acceptance threshold the initial score was. A presentation such as a visual pop put box is formatted for presentation to a human decision maker. When plural ones of such presentations are pending, the bidder's machine prioritizes them according to the initial score given and shuffles them so that the human decision maker will pick the candidate that is most likely to be approved first (thus increasing the odds for this bidder developing a history as a frequent acceptor rather than a frequent rejecter of sneak peeks). Step 552 is periodically consulted to see if the manual decision timer has run out for each pending case. If yes, control is passed to step 526 and the sneak peek is automatically indicated to have been rejected. On the other hand, if the manual timer has not run out and the human decision maker readjusts the score (up or down), control is passed to step 555 for fetching the human adjusted score. Control then passes via path 556 to step 546 for finally determining whether the readjusted score qualifies as a rejection (then go to 526) or an acceptance (then go to 536).

The present disclosure is to be taken as illustrative rather than as limiting the scope, nature, or spirit of the subject matter claimed below. While a number of algorithms have been presented here for dealing with contingencies that can develop during sneak peek operations and for integrating sneak peek operations into a general trading system, numerous modifications and variations may become apparent to those skilled in the art after studying the disclosure, including use of equivalent functional and/or structural substitutes for elements described herein, use of equivalent functional couplings for couplings described herein, and/or use of equivalent functional steps for steps described herein. Such insubstantial variations are to be considered within the scope of what is contemplated here. Moreover, if plural examples are given for specific means, or steps, and extrapolation between and/or beyond such given examples is obvious in view of the present disclosure, then the disclosure is to be deemed as effectively disclosing and thus covering at least such extrapolations.

By way of a further example, it is understood that the configuring of the match and bid system 130 and/or the configuring of each bidder's machine 155 in accordance with the disclosure can include use of a software downloading server (computer) for activating one or more of the functions or activities described herein or equivalents thereof. A computer-readable medium (e.g., 156 of FIG. 1) or another form of a software creating means or machine-instructing means (including but not limited to, a hard disk, a compact disk, a flash memory stick, a downloading of manufactured instructing signals and/or data signals over a network) may be used for instructing one or more instructable machines within the overall system (e.g., 100) to carry out the various activities described here, where the activities can include selective activation of different bidding profiles, selective activation of sneak peek subscriptions associated with respective ones of the bidding profiles, selective adjustments made to the sneak peek subscriptions and/or their associated bidding profiles based on historic experience with their performance, and automated acceptance or rejection of bid-upon informational items (i.e., leads) based on information garnered from sneak peek transmissions. As such, it is within the scope of the disclosure to have an instructable machine carry out, and/to provide a software product and/or components adapted for causing an instructable machine to carry out one or more of the various machine-implemented methods described herein.

### Reservation of Extra-Patent Rights, Resolution of Conflicts, and Interpretation of Terms

After this disclosure is lawfully published, the owner of the present patent application has no objection to the reproduction by others of textual and graphic materials contained herein provided such reproduction is for the limited purpose of understanding the present disclosure of invention and of thereby promoting the useful arts and sciences. The owner does not however disclaim any other rights that may be lawfully associated with the disclosed materials, including but not limited to, copyrights in any computer program listings or art works or other works provided herein, and to trademark or trade dress rights that may be associated with coined terms or art works provided herein and to other otherwise-protectable subject matter included herein or otherwise derivable herefrom.

If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

Unless expressly stated otherwise herein, ordinary terms have their corresponding ordinary meanings within the respective contexts of their presentations, and ordinary terms of art have their corresponding regular meanings within the relevant technical arts and within the respective contexts of their presentations herein.

Given the above disclosure of general concepts and specific embodiments, the scope of protection sought is to be defined by the claims appended hereto. The issued claims are not to be taken as limiting Applicant's right to claim disclosed, but not yet literally claimed subject matter by way of one or more further applications including those filed pursuant to 35 U.S.C. §120 and/or 35 U.S.C. §251.

What is claimed is:

1. A machine-implemented method of combining closer peek operations with other automated bidding and contest running operations that do not provide closer peeks where each of the closer peek operations and peekless bidding operations is responsive to a receiving of one or more bids on an offered informational item, said method comprising:
(a) automatically determining whether a currently highest scoring bidder or a highest scoring group of plural bidders participating in a machine-mediated bidding contest for an offered informational item has a subscription to one or more closer peek privileges for a type of informational item that is being bid on;
(b) in response to detection of a highest scoring individual bidder not having such a subscription, flagging the currently highest scoring individual bidder as the final winner of the contest for the informational item;
(c) in response to the individual bidder or group of bidders having such a closer peek subscription, flagging the currently highest scoring individual bidder or highest scoring group as a potential recipient or group of recipients of one or more closer peek transmissions that will provide additional information relating to the bid-upon informational item, said additional information being more than what the currently highest scoring bidder or members of the highest scoring group could each extract from knowing that that bidder's bid is one of the currently highest scoring bids in the contest; and
(d) providing a so-flagged potential recipient or group of recipients of a closer peek transmission with an ability to perform at least one of the following activities: (d.1) receive the closer peek transmission, (d.2) affirmatively reject the contested for the informational item after having been offered the closer peek or having been given the closer peek, (d.3) affirmatively accept the contested for the informational item after having been offered the closer peek or having been given the closer peek, and (d.4) not respond to at least one of a closer peek transmission or to a transmitted invitation to receive the closer peek transmission.

2. The machine-implemented method of claim 1 wherein the bid-upon informational item includes a lead to a prospective consumer of predefined goods and/or services.

3. The machine-implemented method of claim 2 wherein the lead is a hot contact lead.

4. The machine-implemented method of claim 1 wherein additional information relating to the bid-upon informational item includes at least one of:
(c.1) higher resolution location information about a location to which the bid-upon informational item relates where the higher resolution location information identifies said location with greater resolution than a resolution that the currently highest scoring bidder could obtain from knowing that his or her bid is the currently highest scoring bid;
(c.2) higher resolution timing information about a time window to which the bid-upon informational item relates where the higher resolution timing information identifies said time window with greater resolution than a resolution that the currently highest scoring bidder could obtain from knowing that his or her bid is the currently highest scoring bid;
(c.3) higher resolution personhood information about a person to which the bid-upon informational item relates where the higher resolution personhood information reveals something about said person with greater resolution of revelation than a resolution that the currently highest scoring bidder could obtain from knowing that his or her bid is the currently highest scoring bid; and
(c.4) higher resolution product information about a product and/or service associated with said informational item.

5. The machine-implemented method of claim 1 wherein said step (d) of providing the so-flagged potential recipient with an ability to perform includes:
(d.5) sending a time-limited invitation to a pre-designated responder machine, the invitation being to receive the closer peek transmission.

6. The machine-implemented method of claim 1 wherein said step (d) of providing the so-flagged potential recipient with an ability to perform includes:
(d.6) treating failure to respond to the invitation with the time limit of the invitation as a rejection by the so-flagged potential recipient of the contested for the informational item.

7. The machine-implemented method of claim 1 wherein:
(a.1) said machine-mediated bidding contest for an offered informational item employs a process of stochastically rescoring initial scores or deterministically re-scored scores awarded to bidders participating in said machine-mediated bidding contest.

8. The machine-implemented method of claim 1 wherein:
(a.1) at least one of said group of bidders is a blast mode group; and
(d.1) said step of providing includes providing a plurality of closer peek transmissions to the blast mode group at substantially a same time.

9. The machine-implemented method of claim 8 and further comprising:
(e) starting a response timer for the blast mode group so as to define a maximum time within which members of the blast mode group are to respond to said provision of the plurality of closer peek transmissions.

10. The machine-implemented method of claim 8 and further comprising:
(e) conducting a bidding contest among accepting members of the blast mode group.

11. The machine-implemented method of claim 10 wherein:
(e.1) said bidding contest is initiated in response to determining that there are at least two acceptances and in response to determining at least that one of the following conditions is satisfied: responses have been received from all members of the blast mode group or the blast mode response timer has run out.

12. The machine-implemented method of claim 10 wherein:
(e.1) said bidding contest is initiated in response to determining that a plurality of acceptances have been received from the blast mode group and the number of received acceptances matches or exceeds a predefined threshold value.

13. The machine-implemented method of claim 1 wherein:
(d.5) said step (d) of providing the so-flagged potential recipients with abilities to perform activities includes at least said activity (d.1) of receiving the closer peek transmission and said activity (d.3) of affirmatively accepting the contested for the informational item.

14. The machine-implemented method of claim 13 wherein:
(d.6) said step (d) further includes at least said activity (d.4) of not responding to a closer peek transmission.

15. The machine-implemented method of claim 13 wherein:
(d.6) said step (d) further includes providing a so-flagged group of recipients of a closer peek transmission each with an ability to modify their respective bid amount after having been given the closer peek.

16. The machine-implemented method of claim 1 and further comprising:
(e) before said step (a), carrying out a first machine-mediated bid collecting and scoring process that automatically scores bid signals belonging to respective bidders so as to thereby identify at least one of said currently highest scoring individual bidder and highest scoring group of plural bidders.

17. The machine-implemented method of claim 16 wherein:
(e.1) said collecting and scoring process includes stochastic rescoring of initial scores assigned to the bid signals of the respective bidders where the stochastic rescoring is responsive to peek behavior signals that indicate how well the respective bidders have been behaving historically when participating in closer peek operations, where the peek behavior signals are provided by a supervising system that supervises said closer peek operations and said other automated bidding and contest running operations that do not provide closer peeks.

18. The machine-implemented method of claim 16 wherein:
(e.2) said peek behavior signals are functions of at least one of: recorded histories of time-outs attributed to the respective bidders, recorded histories of rejections attributed to the respective bidders, recorded histories of slowness of responses attributed to the respective bidders, recorded histories of quickness of acceptances attributed to the respective bidders, and frequency of acceptances attributed to the respective bidders.

19. The machine-implemented method of claim 16 wherein:
(e.1) said collecting and scoring process includes deterministic rescoring of initial scores assigned to the bid signals of the respective bidders where the stochastic rescoring is responsive to peek behavior signals that indicate how well the respective bidders have been behaving historically when participating in closer peek operations, where the peek behavior signals are provided by a supervising system that supervises said closer peek operations and said other automated bidding and contest running operations that do not provide closer peeks.

20. The machine-implemented method of claim 19 wherein:
(e.2) said peek behavior signals are functions of at least one of: recorded histories of time-outs attributed to the respective bidders, recorded histories of rejections attributed to the respective bidders, recorded histories of slowness of responses attributed to the respective bidders, recorded histories of quickness of acceptances attributed to the respective bidders, and frequency of acceptances attributed to the respective bidders.

21. The machine-implemented method of claim 16 and further comprising:
(f) before said step (e), carrying out a profile to item matching process that automatically matches informational items that are submitted for bidding thereupon with bidding profiles that specify to a first level of resolution, attributes of informational items that are to be matched with the respective bidding profiles, where said closer peek operations provide peeks at one or more attributes of the informational items to a second level of resolution that is finer than said first level of resolution.

22. An automated trading system that provides closer peek functions in combination with other automated bidding and contest running functions that do not provide closer peeks where each of the closer peek functions and peekless bidding functions is responsive to activation of one or more bids on an offered informational item, said system comprising:
(a) first means for automatically determining whether a currently highest scoring bidder or a highest scoring group of plural bidders participating in a machine-mediated bidding contest for an offered informational item has a subscription to one or more closer peek privileges for a type of informational item that is being bid on;
(b) first flagging means that is responsive to detection of a highest scoring individual bidder not having such a subscription, for flagging the currently highest scoring individual bidder as the final winner of the contest for the informational item;
(c) second flagging means that is responsive to the individual bidder or group of bidders having such a closer peek subscription, for flagging the currently highest scoring individual bidder or highest scoring group as a potential recipient or group of recipients of one or more closer peek transmissions that will provide additional information relating to the bid-upon informational item, said additional information being more than what the currently highest scoring bidder or members of the highest scoring group could each extract from knowing that that bidder's bid is one of the currently highest scoring bids in the contest; and
(d) peek providing means for providing a so-flagged potential recipient or group of recipients of a closer peek transmission with an ability to perform at least one of the following activities: (d.1) receive the closer peek transmission, (d.2) affirmatively reject the contested for the informational item after having been offered the closer peek or having been given the closer peek, (d.3) affirmatively accept the contested for the informational item after having been offered the closer peek or having been given the closer peek, and (d.4) not respond to at least one of a closer peek transmission or to a transmitted invitation to receive the closer peek transmission.

23. The system of claim 22 wherein the bid-upon informational item includes a lead to a prospective consumer of predefined goods and/or services.

24. The system of claim 22 wherein the lead is a hot contact lead.

25. The system of claim 22 wherein additional information relating to the bid-upon informational item includes at least one of:
(c.1) higher resolution location information about a location to which the bid-upon informational item relates where the higher resolution location information identifies said location with greater resolution than a resolution that the currently highest scoring bidder could obtain from knowing that his or her bid is the currently highest scoring bid;
(c.2) higher resolution timing information about a time window to which the bid-upon informational item relates where the higher resolution timing information identifies said time window with greater resolution than a resolution that the currently highest scoring bidder could obtain from knowing that his or her bid is the currently highest scoring bid;
(c.3) higher resolution personhood information about a person to which the bid-upon informational item relates where the higher resolution personhood information reveals something about said person with greater resolution of revelation than a resolution that the currently highest scoring bidder could obtain from knowing that his or her bid is the currently highest scoring bid; and
(c.4) higher resolution product information about a product and/or service associated with said informational item.

26. The system of claim 22 wherein said peek providing means includes:
(d.5) means for sending a time-limited invitation to a pre-designated responder machine, the invitation being to receive the closer peek transmission.

27. The system of claim 26 wherein said peek providing means includes:
(d.6) means for treating failure to respond to the invitation within the time limit of the invitation as a rejection by the so-flagged potential recipient of the contested for the informational item.

28. The system of claim 22 and further comprising:
(a.1) means for carrying out said machine-mediated bidding contest for an offered informational item which employs a process of stochastically rescoring initial scores or deterministically re-scored scores awarded to bidders participating in said machine-mediated bidding contest.

29. The system of claim 22 wherein:
(a.1) at least one of said group of bidders is a blast mode group; and
(d.1) said peek providing means includes means for providing a plurality of closer peek transmissions to the blast mode group at substantially a same time.

30. The system of claim 29 wherein said peek providing means includes:
(d.6) a response timer provided for the blast mode group for defining a maximum time within which members of the blast mode group are to respond to said provision of the plurality of closer peek transmissions.

31. The system of claim 29 and further comprising:
(e) means for conducting a bidding contest among accepting members of the blast mode group.

32. The system of claim 31 wherein said means for conducting a bidding contest includes:
(e.1) first means for determining if at least two acceptances have been produced by the blast mode group; and
(e.2) second first means for determining at least if one of the following conditions is satisfied: (e.2a) responses have been received from all members of the blast mode group; (e.2b) a number of acceptances have been received from the blast mode group where the number of received acceptances is equal to or greater than a predefined, contest-initiating value or a predefined, multi-award enabling value; and (e.2c) a blast mode response timer has run out.

33. The system of claim 22 wherein:
said peek providing means provides a so-flagged potential recipient or group of recipients the ability to receive the closer peek transmission and to indicate acceptability of the contested-for informational item.

34. The system of claim 33 wherein:
said peek providing means further provides a so-flagged potential recipient or group of recipients the ability to not respond to a closer peek transmission.

35. The system of claim 33 wherein:
said peek providing means further provides a so-flagged potential recipient or group of recipients the ability to modify their respective bid amount after having been given the closer peek.

36. The system of claim 22 and further comprising:
(e) bid receiving, matching and initial scoring means configured to carry out a first machine-mediated bid collecting process that collects bid signals belonging to respective bidders and that matches the bid signals with corresponding informational items, and that automatically scores the matched bid signals so as to thereby identify at least one of said bid signals as belonging to a currently highest scoring individual bidder or to a member of a currently highest scoring group of plural bidders.

37. The system of claim 36 wherein:
(e.1) said bid receiving, matching and initial scoring means includes stochastic rescoring means for stochastically rescoring preliminary scores assigned to the bid signals of the respective bidders where the stochastic rescoring is responsive to supplied peek behavior signals that indicate how well the respective bidders have been behaving historically when participating in closer peek operations provided by said peek providing means, where the peek behavior signals are provided by a supervising system that supervises operations of said peek providing means and operations of other automated bidding and contest running means that do not provide closer peeks.

38. The system of claim 37 wherein:
(e.2) said peek behavior signals are functions of at least one of: recorded histories of time-outs attributed to the respective bidders, recorded histories of rejections attributed to the respective bidders, recorded histories of slowness of responses attributed to the respective bidders, recorded histories of quickness of acceptances attributed to the respective bidders, and frequency of acceptances attributed to the respective bidders.

39. The system of claim 36 wherein:
(e.1) said bid receiving, matching and initial scoring means includes deterministic rescoring means for deterministically rescoring preliminary scores assigned to the bid signals of the respective bidders where the stochastic rescoring is responsive to supplied peek behavior signals that indicate how well the respective bidders have been behaving historically when participating in closer peek operations provided by said peek providing means, where the peek behavior signals are provided by a supervising system that supervises operations of said peek providing means and operations of other automated bidding and contest running means that do not provide closer peeks.

40. The system of claim 36 wherein:
(e.1) said bid receiving, matching and initial scoring means carries out a profile to item matching process that automatically matches informational items that are submitted for bidding thereupon with submitted bidding profiles that specify to a first level of resolution, attributes of informational items that are to be matched with the respective bidding profiles, where said closer peek operations provide peeks at one or more attributes of the informational items to a second level of resolution that is finer than said first level of resolution.

41. A machine-supported method for performance with aid of an instructable first machine where the first machine is operatively connectable to a second machine and the second machine can send to the first machine a sneak peek transmission representing a full or partial sneak peek at previously withheld details concerning an informational item that has been at least once bid upon within the second machine, the machine-supported method comprising:
(a) causing the first machine to receive data included in a sneak peek transmission, said received data including peekable-at data representing a full or partial sneak peek at previously withheld details concerning a corresponding informational item that has been bid upon;
(b) causing the first machine to automatically perform a predefined first analysis of the peekable-at data received in the sneak peek transmission and to generate a first evaluation score representing an initial determination of whether to automatically indicate acceptability of the bid upon informational item; and
(c) causing the first machine to automatically output an indication of acceptability based on the first evaluation score.

42. The machine-supported method of claim 41 wherein:
(b.1) said predefined first analysis assigns a normalized comparative value to the peekable-at data indicative of where on a normalized valuation scale the bid upon informational item falls relative to predefined other informational items of pre-judged high and low valuations.

43. The machine-supported method of claim 41 and further comprising:
(d) causing the first machine to determine whether to present part or all of the peeked-at data and/or part or all of the analysis performed by said first machine to a human analyzer for further scoring.

44. The machine-supported method of claim 41 and further comprising:
(d) causing the first machine to determine based on either the first evaluation score or on a secondary score derived from the first evaluation score whether or not to output a rejection indication that indicates a final rejection of the bid upon informational item.

45. The machine-supported method of claim 41 and further comprising:
(d) causing the first machine to define a post-win operation that defines how the bid-upon informational item is to be processed if and after ownership rights over the bid-upon informational item are awarded to a party controlling the first machine or to a second party delegated by said controlling party.

46. The machine-supported method of claim 45 wherein:
(d.1) said processing of the informational item includes guiding a third party to a network location designated by the first machine on the basis of information obtained from said peekable-at data received in the sneak peek transmission.

47. A machine-supported method for performance with aid of an instructable first machine where the first machine is operatively connectable to a second machine and the second machine can enroll the first machine under one or more subscriptions for receiving sneak peek transmissions and thereafter send to the first machine sneak peek transmissions representing full or partial sneak peeks at previously withheld details concerning informational items that have been at least once bid upon within the second machine, the machine-supported method comprising:
(a) causing the first machine to automatically determine whether a current sneak peek subscription under evaluation is resulting in an excessive number of rejections for informational items offered under the sneak peek subscription such that maintenance of the sneak peek subscription in its current configuration is not economically acceptable.

48. The machine-supported method of claim 47 and further comprising:
(b) causing the first machine to automatically drop or reduce use of the subscription under evaluation if said step (a) indicates that maintenance of the sneak peek subscription in its current configuration is not economically acceptable.

49. The machine-supported method of claim 47 and further comprising:
(b) causing the first machine to automatically alter a bidding profile associated with the subscription under evaluation if said step (a) indicates that maintenance of the sneak peek subscription in its current configuration is not economically acceptable, where said alteration of the bidding profile reduces an average number of informational items matching per unit time to specifications of the bidding profile.

50. The machine-supported method of claim 47 and further comprising:
(b) causing the first machine to automatically determine whether the current sneak peek subscription under evaluation is resulting in an excessive number of penalties charged for sneak peeks at informational items offered under the sneak peek subscription such that maintenance of the sneak peek subscription in its current configuration is not economically acceptable.

51. The machine-supported method of claim 47 and further comprising:
(b) causing the first machine to automatically determine whether the current sneak peek subscription under evaluation is resulting in a comparatively large number of successful transactions following sneak peeks at informational items offered under the sneak peek subscription such that maintenance or enhancement of the sneak peek subscription in its current configuration is economically desirable.

52. The machine-supported method of claim 51 and further comprising:
(c) causing the first machine to automatically alter a bidding profile associated with the subscription under evaluation if said step (b) indicates that maintenance or enhancement of the sneak peek subscription in its current configuration is economically desirable, where said alteration of the bidding profile increases an average number of informational items matching per unit time to specifications of the bidding profile and/or said alteration of the bidding profile increases an average number of matching informational items won under the bidding profile per unit time.

53. A machine-supported method for performance with aid of an instructable first machine where the first machine is operatively connectable to a plurality of second machines and the second machines can conditionally enroll under one or more subscriptions for receiving sneak peek transmissions and for thereafter receiving sneak peek transmissions representing full or partial sneak peeks at previously withheld details concerning informational items that have been at least once bid upon, the machine-supported method comprising:
(a) causing the first machine to automatically determine how many response time-out violations one of the second machines is responsible for over a predetermined duration and under a sneak peek subscription maintained for the given second machine.

54. The machine-supported method of claim 53 and further comprising:
(b) causing the first machine to automatically determine how many acceptability rejections have been generated by the given one of the second machines over a predetermined duration and under said sneak peek subscription.

55. The machine-supported method of claim 53 and further comprising:
(b) causing the first machine to automatically determine how many unduly slow acceptability indications have been generated by the given one of the second machines over a predetermined duration and under said sneak peek subscription.

56. The machine-supported method of claim 53 and further comprising:
(b) causing the first machine to automatically determine how many desirably quick acceptability indications have been generated by the given one of the second machines over a predetermined duration and under said sneak peek subscription.

57. The machine-supported method of claim 56 and further comprising:
(c) causing the first machine to automatically define reward and/or penalty factors to be assessed against said sneak peek subscription where said rewards tend to increase price discounts awarded to an account of an owner of said subscription and/or where said rewards tend to increase an average volume per unit time of contest wins awarded to the account of the owner of said subscription and/or where said penalties tend to decrease price discounts awarded to the account of the owner of said subscription and/or where said penalties tend to decrease an average volume per unit time of contest wins awarded to the account of the owner of said subscription.

58. A machine-implemented competitive process carried out on blind bids electronically provided by competing bidders for bid-upon informational items where one or more of said competing bidders can subscribe to sneak peek privileges which provide the subscriber with opportunities to take closer looks at details of the bid-upon informational items than may be had without the privileges and where participants who take such closer looks may elect to not participate further in given rounds of the competitive process after having been given opportunities to take closer looks at the informational items of those rounds, where said elections to not participate include at least one of rejecting an informational item or not responding after having been given an opportunity to take a closer look at the informational item, the machine-implemented competitive process comprising:
(a) altering a competition score assigned to a given bidder in response to a recorded history of the given bidder's electing to not participate further in given rounds of the competitive process after having been given opportunities to take closer looks at the informational items of those rounds.

59. The machine-implemented competitive process of claim 58 wherein said alteration of the competition score is performed stochastically.

60. The machine-implemented competitive process of claim 58 wherein said alteration of the competition score is performed deterministically.

61. A match and bid system that provides sneak peek services to bidders who wish to see more details concerning a bid-upon informational item, where the system provides blast mode sneak peeks substantially simultaneously to a plurality of bidders, the system further comprising:
(a) multi-award means for awarding the informational item to a plurality of no more than K accepting bidders after a blast mode sneak peek session is commenced, where K is a system defined integer.

62. The match and bid system of claim 61 where K is an integer between 2 and 5 inclusively.

63. The match and bid system of claim 61 and further comprising:
(b) an automated dummy lead generator for supplying dummy informational items to participants of blast mode sneak peek sessions who exhibit unusually high rejection rates relative rejection rates of average ones of other bidders who also participate in blast mode sneak peek sessions for the same or same type of informational items but do not reject the peeked-at informational items with the same high frequency as do the participants having said unusually high rejection rates, where the definition of an unusually high rejection rate is established by the match and bid system as a function of statistically normal rejection rates for the same type of informational items.

64. A match and bid system that provides sneak peek services to bidders who wish to see more details concerning a bid-upon informational item, where the system provides for sequential sneak peek sessions with each of the sequential sneak peek sessions being limited to one or a blast mode plurality of participants who are given the sneak peek substantially simultaneously, and where said one or more participants of a sneak peek session can all rejected the peeked-at informational item, the system further comprising:
(a) global timer means for keeping track of the total amount of time that a given informational item spends moving from one of the sequential sneak peek sessions to the next without being accepted; and
(b) graceful intervention means for picking up the not-yet accepted informational item after the global timer means meets or exceeds a predefined time out limit and for passing control over the not-yet accepted informational item to a human or robotic system operator.

65. The match and bid system of claim 64 wherein said graceful intervention means includes means for converting a hot-contact lead into a call-back style lead.
